(19) United States
(12) Patent Application Publication
(10) Pub. No.: US 2021/0217412 A1
(43) Pub. Date: Jul. 15, 2021

(54) INFORMATION PROCESSING APPARATUS, INFORMATION PROCESSING SYSTEM, INFORMATION PROCESSING METHOD, AND PROGRAM

(71) Applicant: Sony Corporation, Tokyo (JP)

(72) Inventor: Satoshi Ozaki, Kanagawa (JP)

(73) Assignee: Sony Corporation, Tokyo (JP)

(21) Appl. No.: 15/733,826

(22) PCT Filed: May 10, 2019
(86) PCT No.: PCT/JP2019/018770

§ 371 Date: Nov. 30, 2020

(30) Foreign Application Priority Data
Jun. 7, 2018 (JP) 2018-109295

(51) Int. Cl. G10L 15/22

(52) U.S. Cl. CPC G10L 15/22; G10L 2015/225

(57) ABSTRACT

To achieve an apparatus and a method that identify a task of interest of a user and control display of task correspondence information. The apparatus includes an image analysis unit that performs analysis processing of a captured image, a task control and execution unit that performs processing according to a user utterance, and a display unit that outputs task correspondence information that is display information based on execution of a task in the task control and execution unit. The task control and execution unit performs control of changing the display position and the display shape of the task correspondence information according to a user position and a face or a line-of-sight direction of a user. In a case where a plurality of pieces of task correspondence information is displayed on the display unit, task-based display control is performed such that the display position of each piece of task correspondence information is close to a user position of the user who has requested execution of each task.

### TECHNICAL FIELD

The present disclosure relates to an information processing apparatus, an information processing system, an information processing method, and a program. More specifically, the present disclosure relates to an information processing apparatus, an information processing system, an information processing method, and a program that perform processing and response based on a voice recognition result of a user utterance.

### BACKGROUND ART

Recently, the use of a voice recognition system that performs voice recognition of a user utterance and performs various processing and responses based on the recognition result is increasing.

In this voice recognition system, a user utterance input via a microphone is recognized and understood, and processing is performed in accordance with the recognition.

For example, in a case where a user utters “Tell me about tomorrow's weather”, weather information is acquired from a weather information providing server, a system response based on the acquired information is generated, and the generated response is output from a speaker. Specifically, for example, a system utterance is output such as

System utterance=“Tomorrow's weather is sunny. However, there may be thunderstorms in the evening.”

Devices that perform such voice recognition include mobile devices such as smartphones, smart speakers, agent devices, and signage devices.

In configurations using smart speakers, agent devices, signage devices, and the like, there are many people around these devices in many cases.

The voice recognition device needs to specify a speaker (uttering user) for the device and provide a service requested by the speaker, specifically, for example, processing of displaying display information requested by the speaker.

As a conventional technology disclosing display processing of display information requested by a speaker, there is, for example, Patent Document 1 (Japanese Patent Application Laid-Open No. 2000-187553). This document discloses a configuration in which a gaze position of a speaker is detected from an image captured by a camera or the like, and display information is controlled on the basis of the detection result.

However, for example, in the situation where there are a plurality of users in front of an agent device, and these users are requesting the device to present different information, it is necessary to control the information provided by determining which information each user is interested in. Even if the conventional technology described above is applied, such control is difficult.

### CITATION LIST

### Patent Document

Patent Document 1: Japanese Patent Application Laid-Open No. 2000-187553

### SUMMARY OF THE INVENTION

### Problems to be Solved by the Invention

The present disclosure has been made in view of the problems described above, for example, and has an object to provide an information processing apparatus, an information processing system, an information processing method, and a program that analyze user attention information and perform control of display information based on an analysis result.

Moreover, an object in an embodiment of the present disclosure is to provide, even in a case where there is a plurality of users, an information processing apparatus, an information processing system, an information processing method, and a program that analyze user attention information and perform control of display information based on an analysis result.

### Solutions to Problems

A first aspect of the present disclosure is

an information processing apparatus including:

a voice recognition unit that performs analysis processing of voice input via a voice input unit;

an image analysis unit that performs analysis processing of a captured image input via an imaging unit;

a task control and execution unit that performs processing according to a user utterance; and

a display unit that outputs task correspondence information that is display information based on execution of a task by the task control and execution unit,

in which the task control and execution unit

changes a display position of the task correspondence information according to a user position.

Moreover, a second aspect of the present disclosure is

an information processing system including: an information processing terminal; and a server,

the information processing terminal including:

a voice input unit; an imaging unit;

a task control and execution unit that performs processing according to a user utterance; and

a communication unit that transmits voice acquired via the voice input unit and a captured image acquired via the imaging unit to the server,

in which the server

generates utterance contents of the speaker, an utterance direction, and a user position indicating a position of a user included in the captured image by a camera on the basis of received data from the information processing terminal as analysis information, and

the task control and execution unit of the information processing terminal

uses the analysis information generated by the server to perform execution and control of a task.

Moreover, a third aspect of the present disclosure is

an information processing method performed in an information processing apparatus, the method including:

performing analysis processing of voice input via a voice input unit by a voice recognition unit;

performing analysis processing of a captured image input via an imaging unit by an image analysis unit; and

outputting task correspondence information that is display information based on execution of a task for performing processing according to a user utterance, to a display unit, and changing a display position of the task correspondence information according to a user position by a task control and execution unit.

Moreover, a fourth aspect of the present disclosure is

an information processing method performed in an information processing system including an information processing terminal and a server, the method including:

by the information processing terminal,

transmitting voice acquired via a voice input unit and a captured image acquired via an imaging unit to the server;

by the server,

generating utterance contents of the speaker, an utterance direction, and a user position indicating a position of a user included in the captured image by a camera on the basis of received data from the information processing terminal as analysis information; and

by the information processing terminal,

using the analysis information generated by the server to perform execution and control of a task, and changing a display position of task correspondence information according to the user position generated by the server.

Moreover, a fifth aspect of the present disclosure is

a program that causes information processing to be performed in an information processing apparatus, the program causing:

a voice recognition unit to perform analysis processing of voice input via a voice input unit;

an image analysis unit to perform analysis processing of a captured image input via an imaging unit; and

a task control and execution unit to output task correspondence information that is display information based on execution of a task according to a user utterance to a display unit, and change a display position of the task correspondence information according to a user position.

Note that the program of the present disclosure is a program that can be provided by, for example, a storage medium or a communication medium provided in a computer-readable format to an information processing apparatus or a computer system that can execute various program codes. By providing such a program in a computer-readable format, processing corresponding to the program is achieved on the information processing apparatus or the computer system.

Still other objects, features, and advantages of the present disclosure will become apparent from a detailed description based on embodiments of the present disclosure described later and accompanying drawings. Note that, in this specification, a system is a logical set configuration of a plurality of devices, and is not limited to one in which the devices of each configuration are in the same housing.

### Effects of the Invention

According to the configuration of an embodiment of the present disclosure, an apparatus and a method that identify a task of interest of a user and control display of task correspondence information are achieved.

Specifically, for example, an image analysis unit that performs analysis processing of a captured image, a task control and execution unit that performs processing according to a user utterance, and a display unit that outputs task correspondence information that is display information based on execution of a task in the task control and execution unit. The task control and execution unit performs control of changing the display position and the display shape of the task correspondence information according to a user position and a face or a line-of-sight direction of a user. In a case where a plurality of pieces of task correspondence information is displayed on the display unit, task-based display control is performed such that the display position of each piece of task correspondence information is close to a user position of the user who has requested execution of each task.

With this configuration, an apparatus and a method that identify a task of interest of a user and control display of task correspondence information are achieved.

Note that the effects described in this specification are merely examples, and the present invention is not limited thereto, and may have additional effects.

### BRIEF DESCRIPTION OF DRAWINGS

FIG. 1 is a diagram for explaining a specific processing example of an information processing apparatus that performs a response to a user utterance.

FIG. 2 is a diagram for explaining a configuration example and a use example of the information processing apparatus.

FIG. 3 is a diagram for explaining a configuration example of the information processing apparatus of the present disclosure.

FIG. 4 is a diagram for explaining a configuration example of the information processing apparatus of the present disclosure.

FIG. 5 is a diagram for explaining an example of data stored in a user information database (DB).

FIG. 6 is a diagram for explaining a configuration example of the information processing apparatus of the present disclosure.

FIG. 7 is a diagram for explaining an example of data stored in a task information database (DB).

FIG. 8 is a diagram for explaining a specific example of processing performed by the information processing apparatus of the present disclosure.

FIG. 9 is a diagram for explaining a specific example of processing performed by the information processing apparatus of the present disclosure.

FIG. 10 is a diagram for explaining a specific example of processing performed by the information processing apparatus of the present disclosure.

FIG. 11 is a diagram for explaining a specific example of processing performed by the information processing apparatus of the present disclosure.

FIG. 12 is a diagram for explaining a specific example of processing performed by the information processing apparatus of the present disclosure.

FIG. 13 is a diagram for explaining a specific example of processing performed by the information processing apparatus of the present disclosure.

FIG. 14 is a diagram for explaining a specific example of processing performed by the information processing apparatus of the present disclosure.

FIG. 15 is a diagram for explaining a specific example of processing performed by the information processing apparatus of the present disclosure.

FIG. 16 is a diagram for explaining a specific example of processing performed by the information processing apparatus of the present disclosure.

FIG. 17 is a diagram for explaining a specific example of processing performed by the information processing apparatus of the present disclosure.

FIG. 18 is a diagram for explaining a specific example of processing performed by the information processing apparatus of the present disclosure.

FIG. 19 is a diagram for explaining a specific example of processing performed by the information processing apparatus of the present disclosure.

FIG. 20 is a diagram for explaining a specific example of processing performed by the information processing apparatus of the present disclosure.

FIG. 21 is a diagram for explaining a specific example of processing performed by the information processing apparatus of the present disclosure.

FIG. 22 is a diagram illustrating a flowchart for explaining a sequence of processing performed by the information processing apparatus.

FIG. 23 is a diagram for explaining a configuration example of an information processing system.

FIG. 24 is a diagram for explaining a hardware configuration example of the information processing apparatus.

### MODE FOR CARRYING OUT THE INVENTION

Hereinafter, details of an information processing apparatus, an information processing system, an information processing method, and a program of the present disclosure will be described with reference to the drawings. Note that the description will be made according to the following items.
1. Outline of processing performed by information processing apparatus
2. Configuration example of information processing apparatus
3. Specific examples of processing performed by information processing apparatus
4. Configuration of determining task of interest of user and performing task control
5. Example of execution task information update processing by task control and execution unit
6. Sequence of processing performed by information processing apparatus
7. Configuration example of information processing apparatus and information processing system
8. Hardware configuration example of information processing apparatus
9. Summary of configuration of present disclosure

### 1. Outline of Processing Performed by Information Processing Apparatus

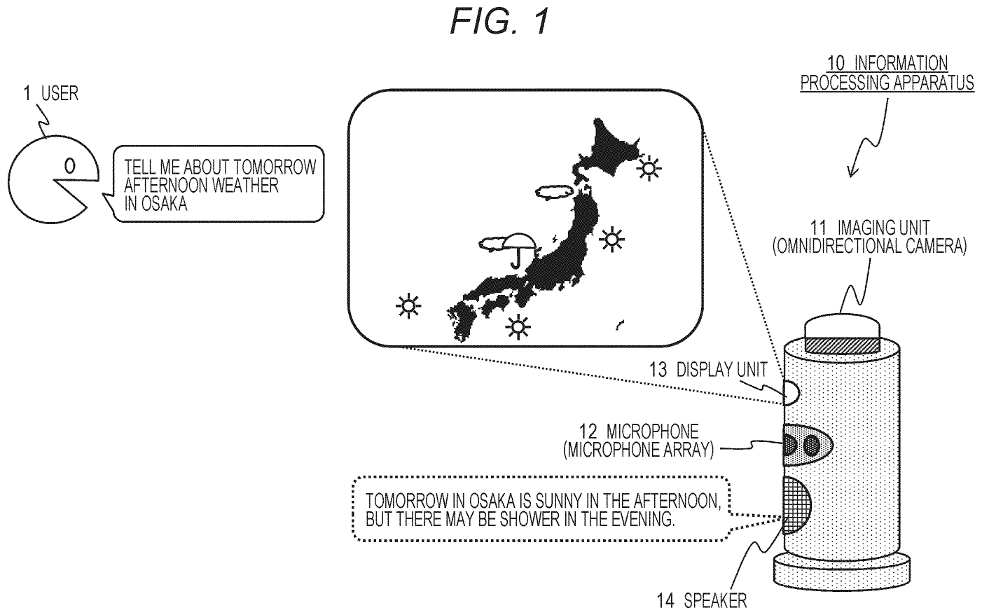

First, an outline of processing performed by an information processing apparatus of the present disclosure will be described with reference to FIG. 1 and subsequent drawings.

FIG. 1 is a diagram illustrating a processing example of an information processing apparatus 10 that recognizes a user utterance made by a speaker 1 and performs a response.

The information processing apparatus 10 performs voice recognition processing of user utterance of the speaker 1, for example,

User utterance=“Tell me about tomorrow afternoon weather in Osaka”.

Moreover, the information processing apparatus 10 performs processing based on the voice recognition result of the user utterance.

In the example illustrated in FIG. 1, data for responding to user utterance=“Tell me about tomorrow afternoon weather in Osaka” is acquired, a response is generated on the basis of acquired data, and the generated response is output via a speaker 14.

In the example illustrated in FIG. 1, the information processing apparatus 10 displays an image showing weather information and makes the following system response.

System response=“Tomorrow in Osaka is sunny in the afternoon, but there may be shower in the evening.”

The information processing apparatus 10 performs a voice synthesis processing (Text To Speech (TTS)) to generate and output the system response described above.

The information processing apparatus 10 generates and outputs a response by using knowledge data acquired from a storage unit in the device or knowledge data acquired via a network.

The information processing apparatus 10 illustrated in FIG. 1 includes an imaging unit 11, a microphone 12, a display unit 13, and a speaker 14, and has a configuration capable of voice input and output and image input and output.

The imaging unit 11 is, for example, an omnidirectional camera capable of capturing an image of approximately 360° around. Furthermore, the microphone 12 is configured as a microphone array including a plurality of microphones capable of specifying a sound source direction.

In the example shown in the drawing, as the display unit 13, a projector type display unit is used. However, the display unit 13 may be a display-type display unit, or may be configured to output display information to a display unit such as a TV or a PC connected to the information processing apparatus 10.

The information processing apparatus 10 illustrated in FIG. 1 is called, for example, a smart speaker or an agent device.

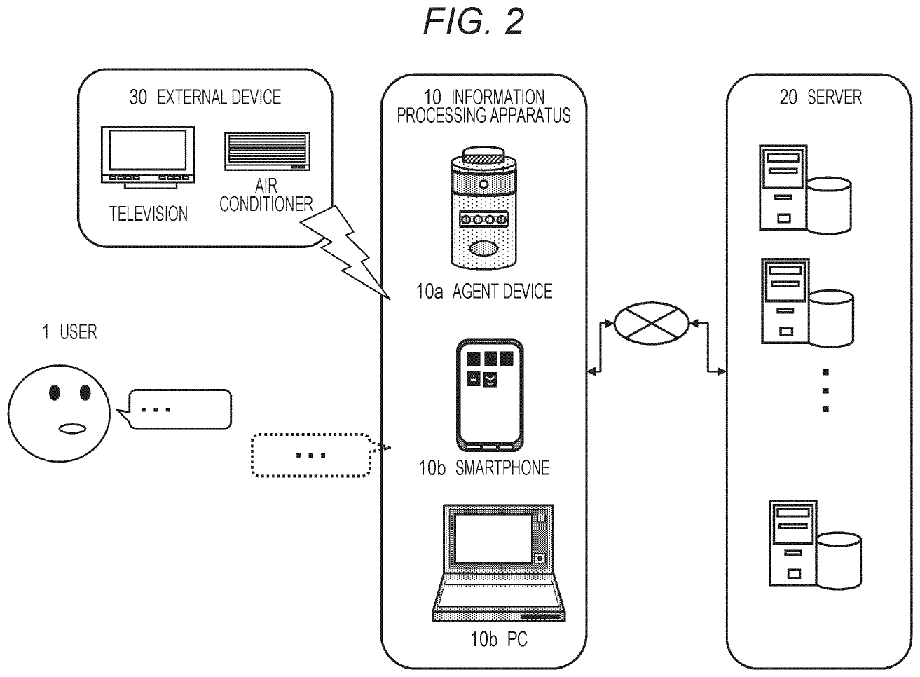

As illustrated in FIG. 2, the information processing apparatus 10 of the present disclosure is not limited to an agent device 10a, and can be various device forms such as a smartphone 10b or a PC 10c, or a signage device installed in a public place.

The information processing apparatus 10 recognizes the utterance of the speaker 1 and performs a response based on the user utterance, and also performs control of an external device 30 such as a television and an air conditioner illustrated in FIG. 2 according to the user utterance.

For example, in a case where the user utterance is a request such as “change the channel of the television to 1” or “set the temperature of the air conditioner to 20 degrees”, the information processing apparatus 10 outputs a control signal (Wi-Fi, infrared light, or the like.) to the external device 30 on the basis of a voice recognition result of the user utterance, and performs control according to the user utterance.

Note that the information processing apparatus 10 is connected to a server 20 via a network, and can acquire information necessary for generating a response to the user utterance from the server 20. Furthermore, a configuration may be adopted where the server performs voice recognition processing and semantic analysis processing.

### 2. Configuration Example of Information Processing Apparatus

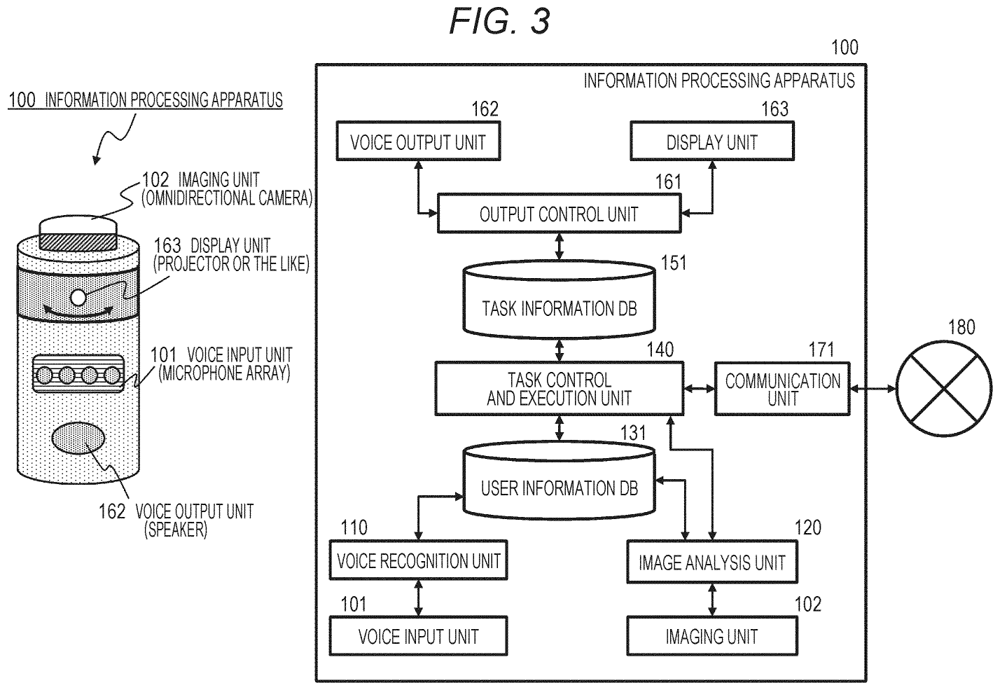

Next, a specific configuration example of the information processing apparatus will be described with reference to FIG. 3.

FIG. 3 illustrates a block diagram illustrating an external configuration and an internal configuration of an information processing apparatus 100 that recognizes a user utterance and performs processing and a response corresponding to the user utterance.

The information processing apparatus 100 illustrated in FIG. 3 corresponds to the information processing apparatus 10 illustrated in FIG. 1.

As illustrated in FIG. 3, the information processing apparatus 100 includes a voice input unit 101, an imaging unit 102, a voice recognition unit 110, an image analysis unit 120, a user information DB 131, a task control and execution unit 140, a task information DB 151, an output control unit 161, a voice output unit 162, a display unit 163, and a communication unit 171. The communication unit 171 communicates with an external device, such as a server that provides various information and applications, for example, via a network 180.

The components of the information processing apparatus 100 illustrated in FIG. 3 will be described.

The voice input unit (microphone) 101 corresponds to the microphone 12 of the information processing apparatus 100 illustrated in FIG. 1. The voice input unit (microphone) 101 is configured as a microphone array including a plurality of microphones capable of specifying a sound source direction.

The imaging unit 102 corresponds to the imaging unit 11 of the information processing apparatus 10 illustrated in FIG. 1. For example, the imaging unit 102 is an omnidirectional camera capable of capturing an image of approximately 360° around.

The voice output unit (speaker) 162 corresponds to the speaker 14 of the information processing apparatus 10 illustrated in FIG. 1.

The display unit 163 corresponds to the display unit 13 of the information processing apparatus 10 illustrated in FIG. 1. For example, the display unit 163 can be configured by a projector or the like, or can be configured as a display unit of a television as an external device. As illustrated in the external configuration diagram on the left side of FIG. 3, the display unit 163 has a rotatable configuration, and the display position of the projector can be set in various directions.

The voice uttered by the user is input to the voice input unit 101 such as a microphone.

The voice input unit (microphone) 101 inputs the input user uttered voice to the voice recognition unit 110.

The imaging unit 102 captures images of the uttering user and the surroundings, and inputs the images to the image analysis unit 120.

The image analysis unit 120 detects the faces of the uttering user and other users, and performs identification of the position or line-of-sight direction of each user, the user, or the like.

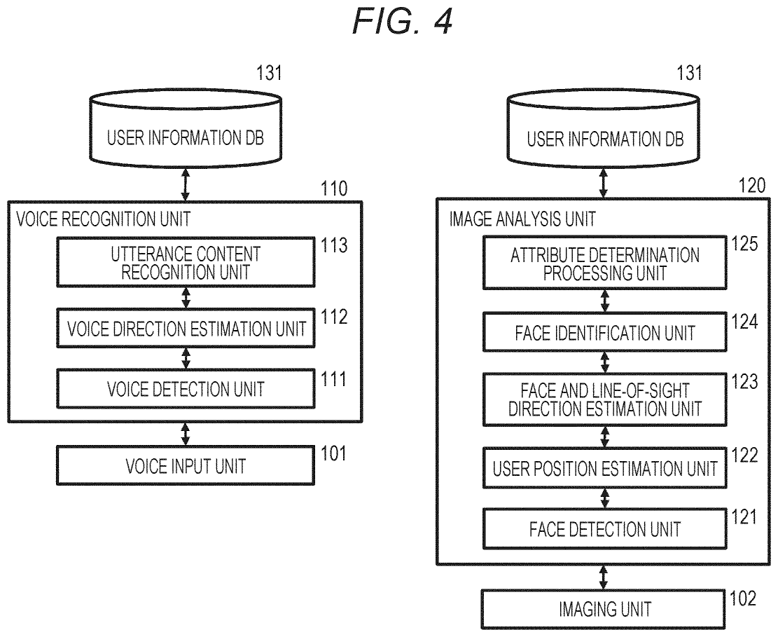

The configurations and processing of the voice recognition unit 110 and the image analysis unit 120 will be described in detail with reference to FIG. 4.

FIG. 4 is a block diagram illustrating the detailed configurations of the voice recognition unit 110 and the image analysis unit 120.

As illustrated in FIG. 4, the voice recognition unit 110 includes a voice detection unit 111, a voice direction estimation unit 112, and an utterance content recognition unit 113.

The image analysis unit 120 includes a face detection unit 121, a user position estimation unit 122, a face and line-of-sight direction estimation unit 123, a face identification unit 124, and an attribute determination processing unit 125.

First, the voice recognition unit 110 will be described. The voice detection unit 111 detects and extracts voice estimated to be a human utterance from various sounds input from the voice input unit 101.

The voice direction estimation unit 112 estimates the direction of the user who made the utterance, that is, the voice direction. As described above, the voice input unit (microphone) 101 is configured as a microphone array including a plurality of microphones capable of specifying a sound source direction.

The acquisition sound of the microphone array is the acquisition sound of the plurality of microphones arranged at a plurality of different positions. The sound source direction estimation unit 112 estimates the sound source direction on the basis of the acquisition sound of the plurality of microphones. Each microphone forming the microphone array acquires a sound signal having a phase difference according to the sound source direction. This phase difference varies depending on the sound source direction. The voice direction estimation unit 112 obtains the sound source direction by analyzing the phase difference between the voice signals acquired by each microphone.

The utterance content recognition unit 113 has, for example, an automatic speech recognition (ASR) function, and converts voice data into text data including a plurality of words. Moreover, the utterance content recognition unit 113 performs utterance semantic analysis processing for the text data.

The utterance content recognition unit 113 has, for example, a natural language understanding function such as natural language understanding (NLU), and estimates the intention of the user utterance from the text data, and entity information that is a meaningful element (significant element) included in the utterance.

A specific example will be described. For example, assume that the following user utterance is input.

User utterance=Tell me the weather in tomorrow afternoon in Osaka

The intention of this user utterance is to want to know the weather, and the entity information is these words, Osaka, tomorrow, and afternoon.

If the intention and the entity information can be accurately estimated and acquired from the user utterance, accurate processing for the user utterance can be performed.

For example, in the example described above, tomorrow afternoon weather in Osaka can be acquired and output as a response.

The voice direction information of the user utterance estimated by the voice direction estimation unit 112 and the content of the user utterance analyzed by the utterance content recognition unit 113 are stored in the user information DB 131.

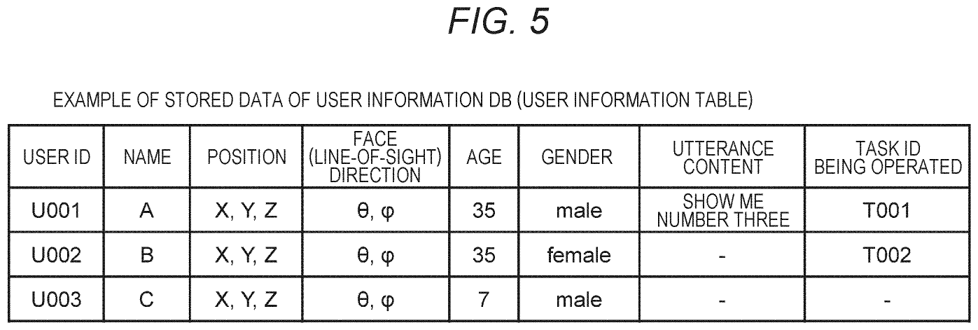

A specific example of data stored in the user information DB 131 will be described later with reference to FIG. 5.

Next, the configuration and processing of the image analysis unit 120 will be described. As illustrated in FIG. 4, the image analysis unit 120 includes the face detection unit 121, the user position estimation unit 122, the face and line-of-sight direction estimation unit 123, the face identification unit 124, and the attribute determination processing unit 125.

The face detection unit 121 detects a human face region from the image captured by the imaging unit 102. This processing is performed by applying an existing method such as collation processing with the facial feature information (pattern information) registered in advance in the storage unit. The user position estimation unit 122 estimates the position of the face detected by the face detection unit 121. The position, size, and the like of the face in the image are used to calculate the distance and direction from the information processing apparatus to determine the position of the user face. The position information is, for example, relative position information with respect to the information processing apparatus. Note that a configuration may be adopted where sensor information such as a distance sensor or a position sensor is used.

The face and line-of-sight direction estimation unit 123 estimates the face direction and line-of-sight direction detected by the face detection unit 121. The position of the eyes of the face, the position of the pupils of the eyes, and the like are detected to detect the face direction and the line-of-sight direction.

The face identification unit 124 sets an identifier (ID) for each of the faces detected by the face detection unit 121. In a case where a plurality of faces is detected in the image, a unique identifier capable of distinguishing each is set. Note that the user information DB 131 stores face information that has already been registered, and in a case where a matching face is identified by the comparison and collation processing with this registered face information, user name (registered name) thereof is also identified.

The attribute determination processing unit 125 acquires attribute information for each user identified by the face identification unit 124, for example, user attribute information such as age and gender. This attribute acquisition processing can be performed by estimating the attribute, for example, adult or child, male or female, on the basis of the captured image. Furthermore, in a case where the face identified by the face identification unit 124 is already registered in the user information DB 131 and the attribute information of the user is already recorded in the DB, this DB registration data may be acquired.

The acquisition and use methods of these components, that is, the face detection unit 121, the user position estimation unit 122, the face and line-of-sight direction estimation unit 123, the face identification unit 124, and the attribute determination processing unit 125 that are included the image analysis unit 120, are registered in the user information DB 131.

FIG. 5 illustrates an example of stored information (user information table) in the user information DB 131.

As illustrated in FIG. 5, a user ID, a user name, a user position, a user face (line-of-sight) direction, a user's age, a user's gender, a user utterance content, and a task ID of a task being operated by the user are registered in the user information DB 131.

These pieces of information, that is, the user ID, the user name, the user position, the user face (line-of-sight) direction, the user's age, and the user's gender, are information acquired by the image analysis unit 120.

The user's utterance content is information acquired by the voice recognition unit 110. The task ID of the task being operated by the user is information registered by the task control and execution unit 140.

The user position (X, Y, Z) is a three-dimensional coordinate position of the user calculated by defining, for example, a certain point in the information processing apparatus 100 as an origin, the front direction of the information processing apparatus 100 as the Z axis, the horizontal direction as the X axis, and the vertical direction as the Y axis.

(θ, φ) shown as registration data of the user face (line-of-sight) direction is angle data obtained by defining, for example, the angle formed by the camera direction of the imaging unit 102 and the face (line-of-sight) direction on the XZ plane described above as 6, and the angle formed by the camera direction of the imaging unit 102 and the face (line-of-sight) direction on the YZ plane as cp.

The age and gender may be information estimated from the face image, or, if the information additionally input by the user himself/herself can be used, that information may be used. Furthermore, if there is registered data in the user information DB 131, that data may be used.

As the utterance content, the voice recognition result of the voice recognition unit 110 is registered in almost real time. The registration data is sequentially updated as the user utterance progresses. For example, in a case where the user utterance is the following utterance,

User utterance=Show me that number three

in a case where such a user utterance is input, the record data of the user information DB 131 is updated over time as described below.

From “That” to “That number three” to “Show me that number three”

Returning to FIG. 3, the description of the configuration of the information processing apparatus 100 will be continued.

In the user information DB 131, in addition to the information described with reference to FIG. 5, pre-registered user information, for example, a face image, a name, and other attributes (age, gender, and the like) are stored in association with the user ID.

In a case where the face detected from the image captured by the imaging unit 102 matches the registered face image, the user attribute can be acquired from this registration information.

The task control and execution unit 140 controls a task performed in the information processing apparatus 100.

The task is a task performed in the information processing apparatus 100, and includes, for example, various tasks as follows.
Tourist destination search task,
Restaurant search task,
Weather information provision task,
Traffic information provision task,
Music information provision task,

These tasks can be performed by using the information and applications stored in the task information DB 151 of the information processing apparatus 100, but also can be performed, for example, by performing communication with an external information providing server, an application execution server, or the like via a communication unit 171 and a network 180 and using external information (data or application).

Note that a specific task execution example will be described in detail later.

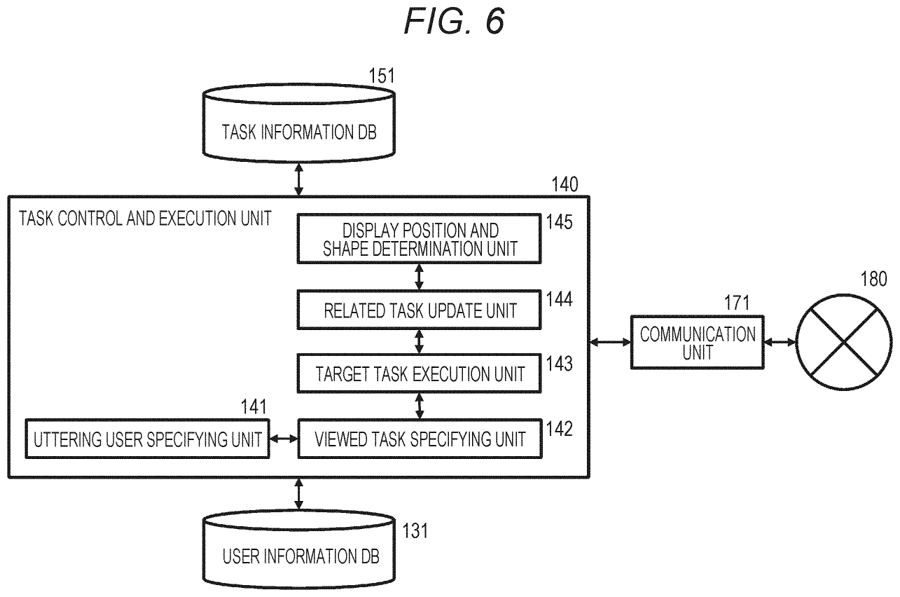

A detailed configuration example of the task control and execution unit 140 will be described with reference to FIG. 6. As illustrated in FIG. 6, the task control and execution unit 140 includes an uttering user specifying unit 141, a viewed task specifying unit 142, a target task execution unit 143, a related task update unit 144, and a display position and shape determination unit 145.

The uttering user specifying unit 141 performs processing for specifying the face of the user who is uttering, from the faces included in the captured image of the imaging unit 102. This processing is performed using the user position information associated with the utterance content stored in the user information DB 131. This processing may be performed as processing of using the estimation information of the utterance direction to specify the user of the face in that direction.

The viewed task specifying unit 142 performs processing for specifying the display task included in the captured image of the imaging unit 102 and viewed by the user. This processing is performed using the user position information stored in the user information DB 131 and the face (line-of-sight) direction information. There is a case where, in the display unit 163, for example,
Tourist destination search task,
Restaurant search task,
these two tasks are displayed side by side. The viewed task specifying unit 142 identifies which of these tasks included in the captured image of the imaging unit 102 the user is viewing. Note that a specific example will be described in detail later.

The target task execution unit 143, for example, specifies a task that the user is viewing or a task whose display is to be changed on the basis of the user utterance, and performs processing related to the task. The related task update unit 144 performs, for example, update processing and the like of a task related to the task being performed. The display position and shape determination unit 145 determines the display position and shape of the task being displayed on the display unit 163, and updates the display information to the determined position and shape.

Note that a specific example of the processing performed by these processing units will be described later in detail.

The task information DB 151 stores data related to a task performed by the information processing apparatus 100, for example, information to be displayed on the display unit 163, applications for task execution, and the like.

Moreover, information associated with the currently executed task (task information table) is also stored.

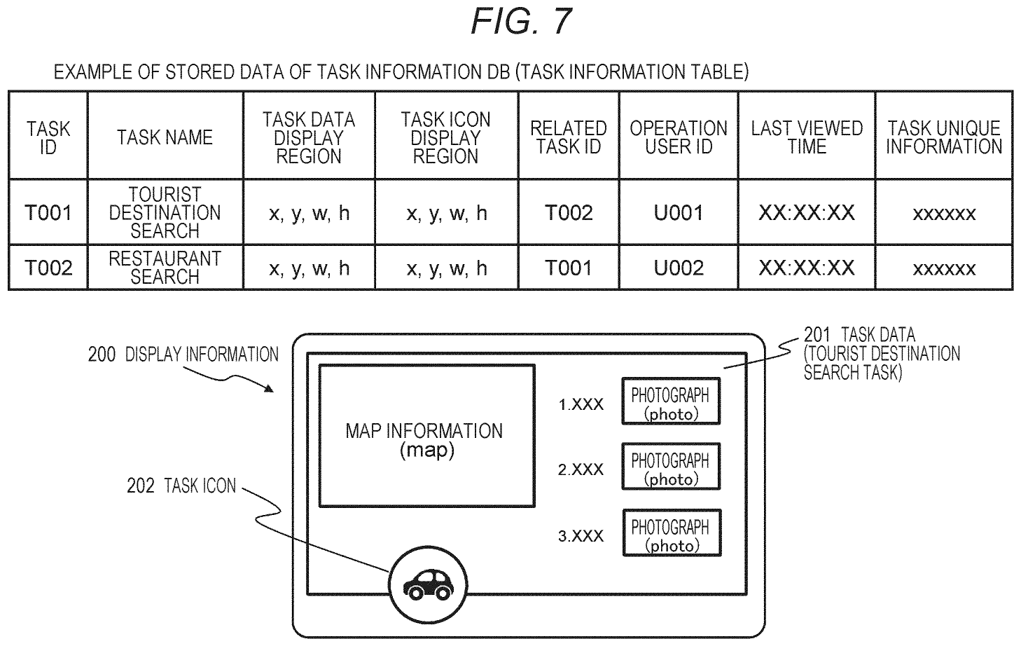

FIG. 7 illustrates an example of information associated with the currently executed task (task information table) stored in the task information DB 151.

As illustrated in FIG. 7, as information associated with the currently executed task (task information table), data of a task ID, a task name, a task data display region, a task icon display region, a related task ID, an operating user ID, a last viewed time, task unique information is recorded in association with each other.

At the bottom of FIG. 7, a display example of task data (tourist destination search task) 201 and a task icon 202 as an example of the display information 200 displayed on the display unit 163 is illustrated.

The task ID and the task name are the ID and task name of the task being displayed on the display unit 163. The task data display region and the task icon display region are data indicating the task data display region and the task icon display region of the task being displayed on the display unit 163. x, y, w, and h are, for example, pixel values on the display screen, and represent a region having a width and height of (w, h) pixels from the position of the pixel (x, y).

The related task is information on the task related to the task being executed, specifically, the task being displayed on the display unit 163, for example. For example, task IDs and the like displayed side by side on the display unit 163 are recorded. As the operation user ID, the user ID of the user who is performing the operation request for the task being displayed on the display unit 163 is recorded. As the last viewed time, the last time information when the user visually recognizes the task being displayed on the display unit 163 is recorded. As the task unique information, unique information related to the task being displayed on the display unit 163 is recorded.

Returning to FIG. 3, other configurations of the information processing apparatus 100 will be described. The output control unit 161 performs control of sound and display information output via the voice output unit 162 and the display unit 163. The output control unit 161 performs display control of a system utterance output via the voice output unit 162, task data output to the display unit 163, task icon and others.

The voice output unit 162 is a speaker and outputs voice of the system utterance.

The display unit 163 is a display unit that uses, for example, a projector, and displays various task data, task icons, and the like.

### 3. Specific Examples of Processing Performed by Information Processing Apparatus

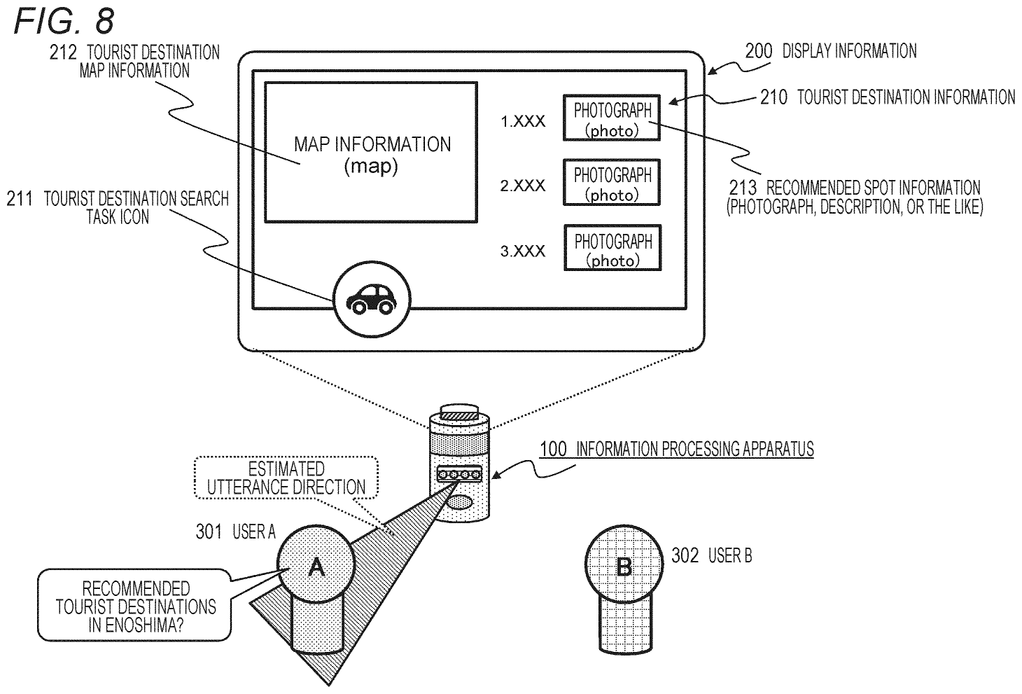

Next, a specific example of processing performed by the information processing apparatus 100 of the present disclosure will be described with reference to FIG. 8 and subsequent drawings.

FIG. 8 illustrates a processing example in a case where two users A, 301 and a user B, 302 are in front of the information processing apparatus 100, and the user A, 301 has made the following user utterances.

User utterance=Recommended tourist destinations in Enoshima

The voice recognition unit 110 of the information processing apparatus 100 performs voice recognition processing of this user utterance and stores the voice recognition result in the user information DB 131.

The task control and execution unit 140 determines that the user is requesting the presentation of information regarding recommended tourist destination in Enoshima on the basis of the user utterance stored in the user information DB 131, and performs the tourist destination search task.

Specifically, for example, the task control and execution unit 140 generates display information 200 based on the tourist destination information acquired from the task information DB 151 or acquired by performing a tourist destination information search application acquired from an external tourist destination information providing server, and outputs the display information 200 to the display unit 163.

The display information 200 includes tourist destination information 210 which is the execution result data of the tourist destination search task, and a tourist destination search task icon 211 indicating that the display information is the execution result of the tourist destination search task. Furthermore, the tourist destination information 210 includes tourist destination map information 212 and recommended spot information (photographs, explanations or the like) 213 as display data.

Note that the voice recognition unit 110 analyzes the utterance direction of the user utterance (direction from the information processing apparatus 100) with the occurrence of the user utterance. Moreover, the image analysis unit 120 analyzes the position and face (line-of-sight) direction of the user A, 301 who has made the user utterance described above.

These analysis results are stored in the user information DB 131.

At this point, the display information 200 on the display unit is in a state in which the tourist destination information 210 including the map information 212 around the Enoshima area and the recommended spot information 213 is displayed on the entire screen.

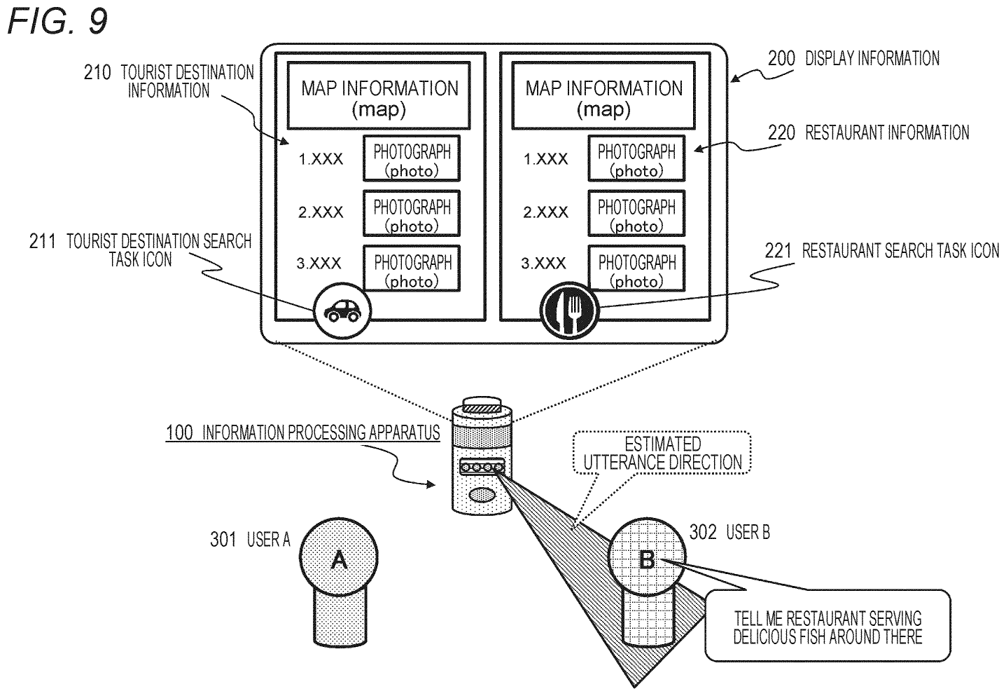

Next, as illustrated in FIG. 9, it is assumed that user B, 302 has made the following user utterance.

User utterance=Tell me a restaurant serving delicious fish around there

The voice recognition unit 110 of the information processing apparatus 100 performs voice recognition processing of this user utterance and stores the voice recognition result in the user information DB 131.

Note that, although the user B, 302 does not use the place name “Enoshima” but the word “around there”, the voice recognition unit 110 determines that the intention of user B, 302 is “Tell me a restaurant serving delicious fish around Enoshima”, since the speech of the user A, 301 immediately before the utterance of the user B, 302 includes “Enoshima”, and registers the utterance content including this intention information in the user information DB131.

The task control and execution unit 140 determines that the user is requesting the presentation of information associated with the restaurant serving delicious fish around Enoshima on the basis of the user utterance stored in the user information DB 131, and performs the restaurant search task.

Specifically, for example, the task control and execution unit 140 generate restaurant information 220 based on the task information DB 151, or restaurant information acquired by performing a restaurant information search application acquired from an external restaurant information providing server, and outputs the restaurant information 220 to a part of the display unit 163.

Note that the task control and execution unit 140 reduces the tourist destination information 210 already displayed in the entire display region of the display unit 163 to the left half display region, and displays the restaurant information 220 in the right half area. The task control and execution unit 140 performs display control processing in which the position of the display region of each piece of information is close to the position of the user who has requested the provision of the information. The display position and shape determination unit 145 of the task control and execution unit 140 performs these pieces of processing.

That is, the tourist destination information 210 is displayed in the display region close to the user A, 301 who has requested the presentation of the tourist destination information, and the restaurant information 220 is displayed in the display region close to the user B, 302 who has requested the presentation of the restaurant information.

Note that the user position information of each user is acquired from the registration information in the user information DB 131.

Note that the voice recognition unit 110 analyzes the utterance direction of the user utterance (direction from the information processing apparatus 100) in response to the user utterance from the user B, 302. Moreover, the image analysis unit 120 analyzes the position and face (line-of-sight) direction of the user B, 302 who has made the user utterance described above.

These analysis results are stored in the user information DB 131.

At this point, the display information 200 on the display unit is in a state where the tourist destination information 210 around Enoshima is displayed in the left half region on the user A side, and the restaurant information 220 around Enoshima is displayed in the right half region on the user B side.

Note that the task control and execution unit 140 records the two tasks currently being executed, that is, the tourist destination search task and the restaurant search task, as related tasks in both task information registration information. That is, the task control and execution unit 140 registers the registration information recording the related task ID as illustrated in FIG. 7 in the task information DB 151.

Note that the task control and execution unit 140 not only determines tasks that are being executed in parallel as related tasks, but also determines that, for example, two tasks as related tasks in a case where common elements such as area and time that are included in the two utterances that has triggered the execution of the two tasks, and registers the related task ID in the task information DB 151. The utterance content is acquired by referring to the registration information in the user information DB 131. For example, also in a case where the user A's utterance is about “Enoshima” and user B's utterance is also about “Enoshima”, two tasks performed on the basis of the two utterances are determined to be related tasks.

Note that the processing related to these related tasks is performed by the related task update unit 144 of the task control and execution unit 140.

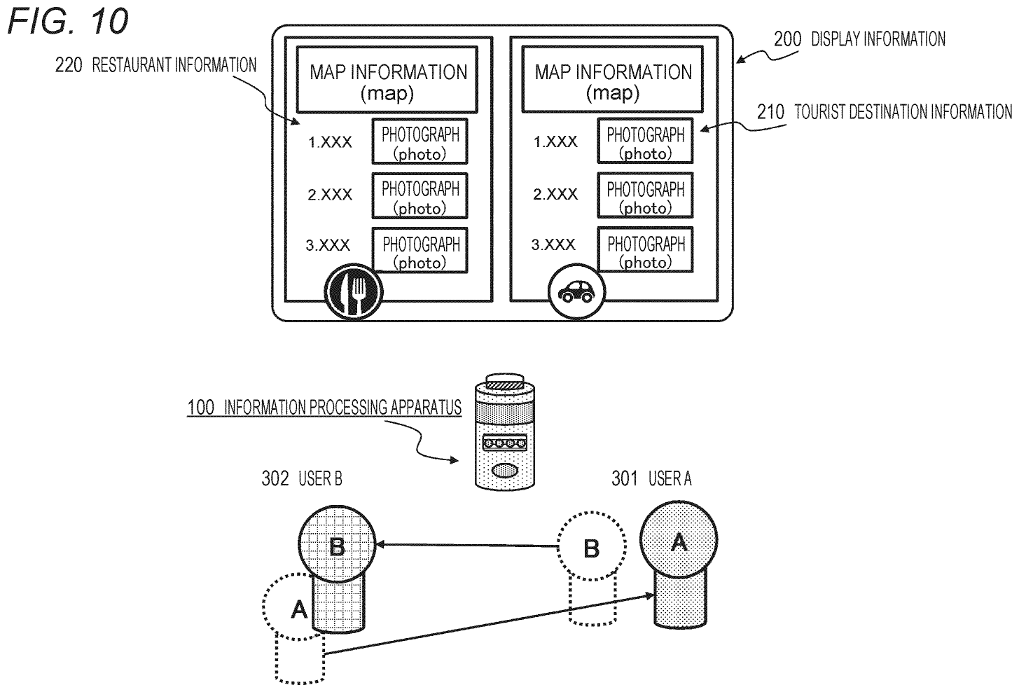

Next, as illustrated in FIG. 10, it is assumed that the user A, 301 and the user B, 302 have moved and the two user positions have been interchanged.

As illustrated in FIG. 10, it is assumed that user A, 301 has moved from the left side to the right side, and user B, 302 has moved from the right side to the left side.

The movement of the users is analyzed by the image analysis unit 120 that analyzes the captured image of the imaging unit 102, and new user position information is registered in the user information DB 131.

The task control and execution unit 140 performs display information update processing of changing the display position of the display information of the display unit 163 on the basis of the update of the user position information registered in the user information DB 131. The display position and shape determination unit 145 of the task control and execution unit 140 performs this processing.

That is, the display position and shape determination unit 145 performs display position change processing of causing the tourist destination information 210 to be displayed in the right display region close to the user A, 301 who has requested the presentation of the tourist destination information, and the restaurant information 220 to be displayed in the left display region close to the user B, 302 who has requested the presentation of the restaurant information.

Note that such changing processing of a display position according to the user position can be set such that the user position is constantly tracked and the display position is sequentially changed on the basis of the tracking information. However, if the display position is changed frequently, the display information becomes difficult to see. Therefore, control may be performed such that a certain degree of hysteresis may be provided to avoid frequent change in the display position.

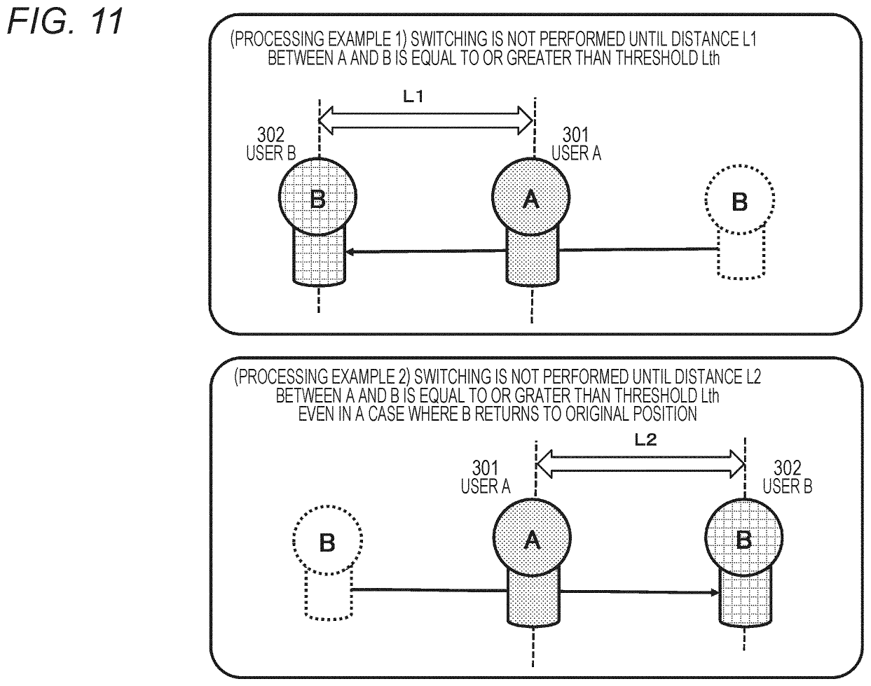

An example of processing of performing the display position change with hysteresis will be described with reference to FIG. 11.

FIG. 11 (processing example 1) illustrates an example in a case where the user B moves from the right side to the left side of the user A.

When the user B is on the right side of the user A, data a as the execution result of a task a requested by the user A is displayed on the left side of the display unit, and data b as the execution result of a task b requested by the user B is displayed on the right side.

In a case where the display position change with hysteresis is performed, when the user B moves from the right side to the left side of the user A and the user B is on the left side of the user A, the display positions of the data a and b are not changed. As illustrated in the drawing, in a case where it is confirmed that a distance L1 between AB is equal to or greater than a specified threshold Lth, the display positions of the data a and b are changed.

(Processing example 2) illustrates an example in a case where the user B moves from the left side to the right side of the user A. Also in this case, when the user B moves from the left side to the right side of the user A and the user B is on the right side of the user A, the display positions of the data a and b are not changed. As illustrated in the drawing, in a case where it is confirmed that a distance L2 between AB is equal to or greater than a specified threshold Lth, the display positions of the data a and b are changed.

By performing such processing, the display position change of the display data of the display unit is not performed frequently, which prevents the display data from being difficult to see.

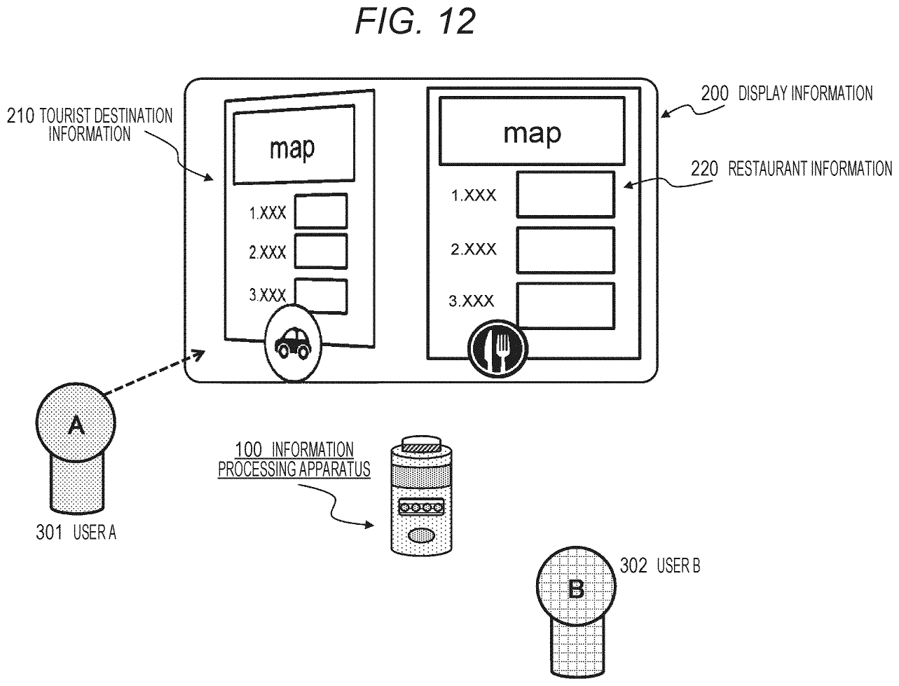

Another control example of the display data performed by the task control and execution unit 140 will be described with reference to FIG. 12.

The example illustrated in FIG. 12 illustrates an example of a display image in a case where the user A is located on the left side far from the front of the display image of the display unit 163.

As described above, in a case where the user A is on the left side or the right side, away from the display image of the display unit 163, the task control and execution unit 140 transforms and displays the display image. That is, for example, in a case where it is determined that the angle between the position of the user A and the projection surface is small, and the display image is difficult to recognize visually, the display mode of the display data that is the execution result of the task is changed so that it is optimal for the user A to view.

The transformation target data is a task being executed by the request of the user A, and in a case of this example, the tourist destination information 210 output to the left half region of the display information 200.

The task control and execution unit 140161 deforms and displays the display data of the tourist destination information 210 so that the display data can be optimally viewed by the user A.

Note that the transformation display processing may be performed only in a case where only the user A is viewing the tourist destination information 210. In a case where the user B on the right side of the display image illustrated in FIG. 12 is also viewing the tourist destination information 210, the transformation processing of the display image is not performed.

The task control and execution unit 140 acquires the position information and face (line-of-sight) direction data of each user recorded in the user information DB 131, determines the data of interest of the user, and performs these controls.

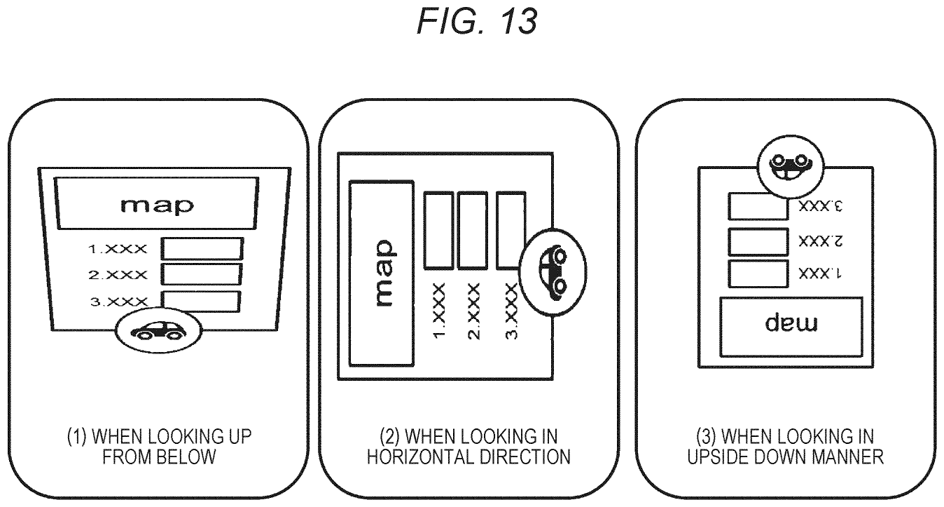

The modification of the display image is not limited to the settings illustrated in FIG. 12, but various settings are available as illustrated in FIG. 13, for example.

FIG. 12(a) is an example of display data in a case where the user looks up at the display image from below.

FIG. 12(b) is an example of display data in a case where the user is looking at the display image in a horizontal direction.

FIG. 12(c) is an example of display data in a case where the user is looking at the display image in an upside down manner.

In either case, the display is transformed so that it looks optimal from the user's viewpoint.

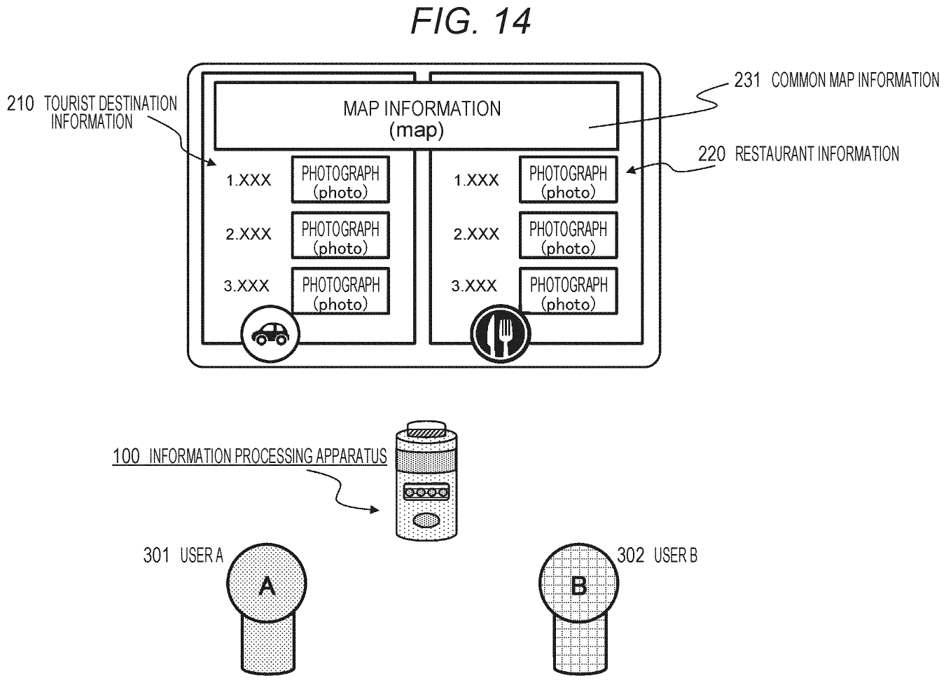

Moreover, with reference to FIG. 14, a control example of display information under the control of the task control and execution unit 140 will be described. The example illustrated in FIG. 14 shows a state where the tourist destination information 210 that is the execution result of the task requested by the user A, and the restaurant information 220 that is the execution result of the task requested by user B are displayed side by side. The tourist destination information 210 and the restaurant information 220 are information associated with the same area. In such a case, the map information that can be commonly used for the two pieces of information is displayed in a large size so as to extend over the two information display regions. That is, large common map information 231 is displayed as illustrated in the drawing.

By performing such display processing, both users A and B can observe a large map.

### 4. Configuration of Determining Task of Interest of User and Performing Task Control

Next, configuration of determining task of interest of user and performing task control will be described.

In the processing example described above, described is an example in which the tourist destination search task is executed by the request of the user A, 301 to display the tourist destination information, and the restaurant search task is executed by the request of the user B, 302 to display the restaurant information.

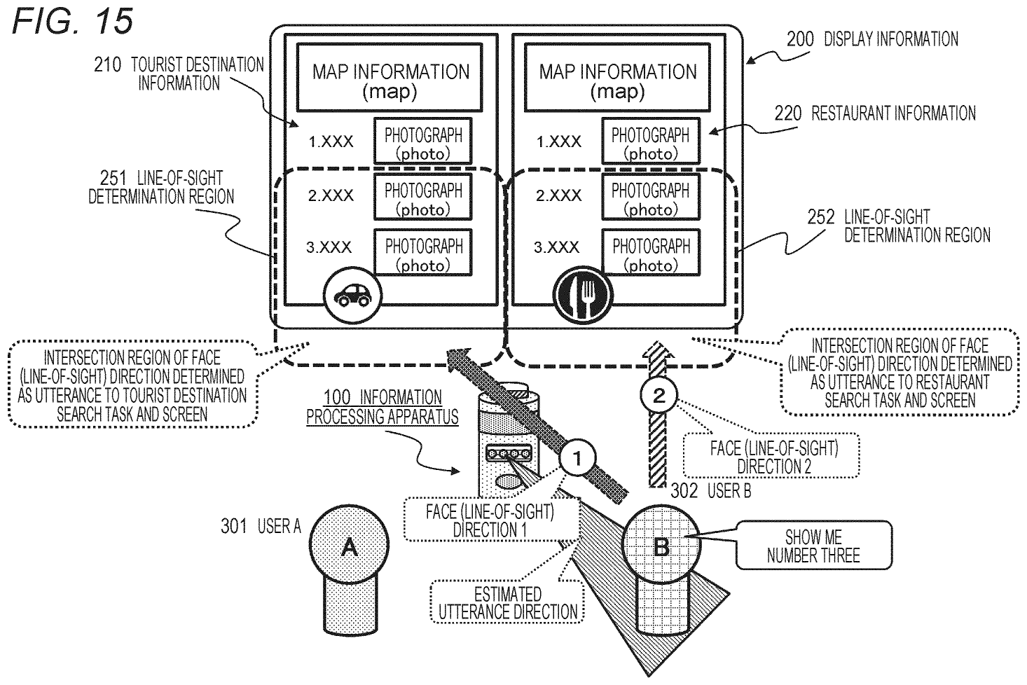

As illustrated in FIG. 15, the tourist destination information 210 is displayed on the left side of the display information 200, and the restaurant information 220 is displayed on the right side.

Here, as illustrated in FIG. 15, it is assumed that the user B, 302 has made the following user utterance.

User utterance=Show me number three

The voice recognition unit 110 of the information processing apparatus 100 analyzes that the intention of the users B, 302 is to want to see the number three, and records the user utterance content in the user information DB 131.

Although the task control and execution unit 140 performs the processing according to the intention of the user B, 302, “Show me number three”, both the tourist destination information 210 and the restaurant information 220 have the same selection items of number one to three.

In such a case, the task control and execution unit 140 determines which of the tourist destination information 210 and the restaurant information 220 the user B is paying attention to at the utterance timing of the users B, 302. That is, at the utterance timing of the user B, 302, the task control and execution unit 140 determines which of the tourist destination information 210 and the restaurant information 220 the line-of-sight of the user B, 302 is directed to, and performs task control according to the determination result.

In a case where it is determined that the line-of-sight of the user B is directed to the tourist destination information 210 at the utterance timing of the user B, 302, processing on the data of number three on the tourist destination information 210 side is performed. On the other hand, in a case where it is determined that the line-of-sight of the user B is directed to the restaurant information 220 at the utterance timing of the user B, 302, processing on the data of number three on the restaurant information 220 side is performed.

The task control and execution unit 140 performs, in this line-of-sight determination processing, for example, processing of determining which of the line-of-sight determination regions 251 and 252 set on the display screen has the face (line-of-sight) direction of the user B, 302, as illustrated in FIG. 15.

In a case where the face (line-of-sight) direction of the user B, 302 is within the line-of-sight determination region 251 of the tourist destination information 210 side, the task control and execution unit 140 determines that the user B, 302 requests the task execution on the tourist destination information 210 side. On the other hand, in a case where the face (line-of-sight) direction of the user B, 302 is within the line-of-sight determination region 252 on the restaurant information 220 side, the task control and execution unit 140 determines that the user B, 302 requests the task execution on the restaurant information 220 side.

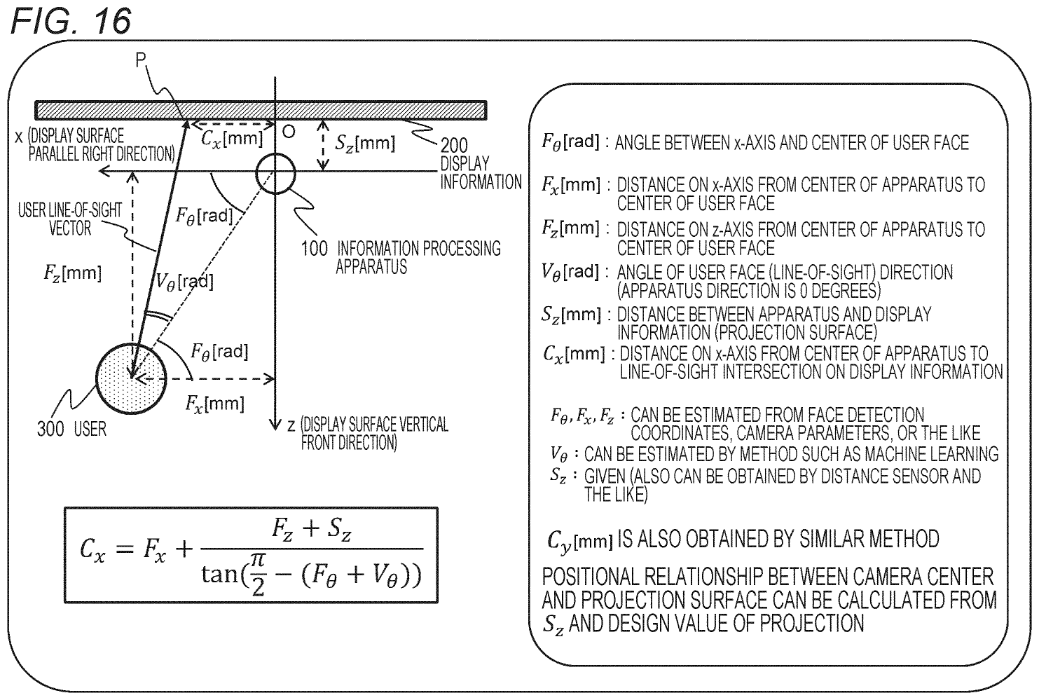

In this processing, it is necessary to detect the intersection of the vector in the line-of-sight direction of the user and the display information. A specific example of this intersection detection processing will be described with reference to FIG. 16.

A line passing from a center position O of the display surface of the display information 200 in the right and left direction to the center of the information processing apparatus 100 is defined as a z-axis, and a line parallel to the display surface of the display information 200 and passing through the center of the information processing apparatus 100 is defined as an x-axis.

At this time, the distance from O to the intersection point P of the line-of-sight vector of a user 300 and the display surface of the display information 200, that is, the distance Cx [mm] between OP can be calculated according to the following (Equation 1).

$$\begin{matrix}[ Math . 1 ] & \\ {C}_{x} = {F}_{x} + \frac{{F}_{z} + {S}_{z}}{tan ( \frac{π}{2} - ( {F}_{θ} + {V}_{θ} ) )} & ( Equation 1 )\end{matrix}$$

However,

Fθ[rad]: Angle between the x-axis and the center of the user face

Fx[mm]: Distance on the x-axis from the center of the information processing apparatus to the center of the user face

Fz[mm]: Distance on the z-axis from the center of the information processing apparatus to the center of the user face

Vθ[rad]: Angle of the user face (line-of-sight) direction (apparatus direction is 0 degrees)

Sz[mm]: Distance between the information processing apparatus and the display information (projection surface)

Of these parameters, the values of Fθ, Fx, Fz, Vθ are values that each can be acquired from the face position information and face (line-of-sight) direction information recorded in the user information DB 131.

Sz is a value that can be acquired from the projector control parameter of the display unit 163. Note that a configuration may be adopted where some of these parameters are measured using a distance sensor included in the information processing apparatus 100.

Although (Equation 1) described above is an equation for calculating the distance in the horizontal direction (x direction) from O to the intersection point P of the display information 200 display surface, the distance in the vertical direction (y direction) from O to the intersection point P of the display information 200 display surface, that is, Cy [mm] can also be calculated using known parameters.

As a result, it is possible to calculate the coordinates of the intersection of the vector in the line-of-sight direction of the user and the display information, specifically, the coordinates (x, y) in a case where the center position of the display information is the origin O.

In a case where the coordinates (x, y) calculated according to the calculation processing described above is within the line-of-sight determination region 251 on the tourist destination information 210 side, the task control and execution unit 140 determines that the user B, 302 requests the task execution on the tourist destination information 210 side, and performs processing related to the task on the tourist destination information 210 side.

On the other hand, in a case where the coordinates (x, y) is within the line-of-sight determination region 252 on the restaurant information 220 side, the task control and execution unit 140 determines that the user B, 302 requests the task execution on the restaurant information 220 side, and performs processing related to the task on the restaurant information 220 side.

Note that in the configuration in which the user's processing request task is determined by detecting the intersection between the vector in the line-of-sight direction of the user and the display surface, the determination is difficult in some cases depending on the setting of the line-of-sight determination region.

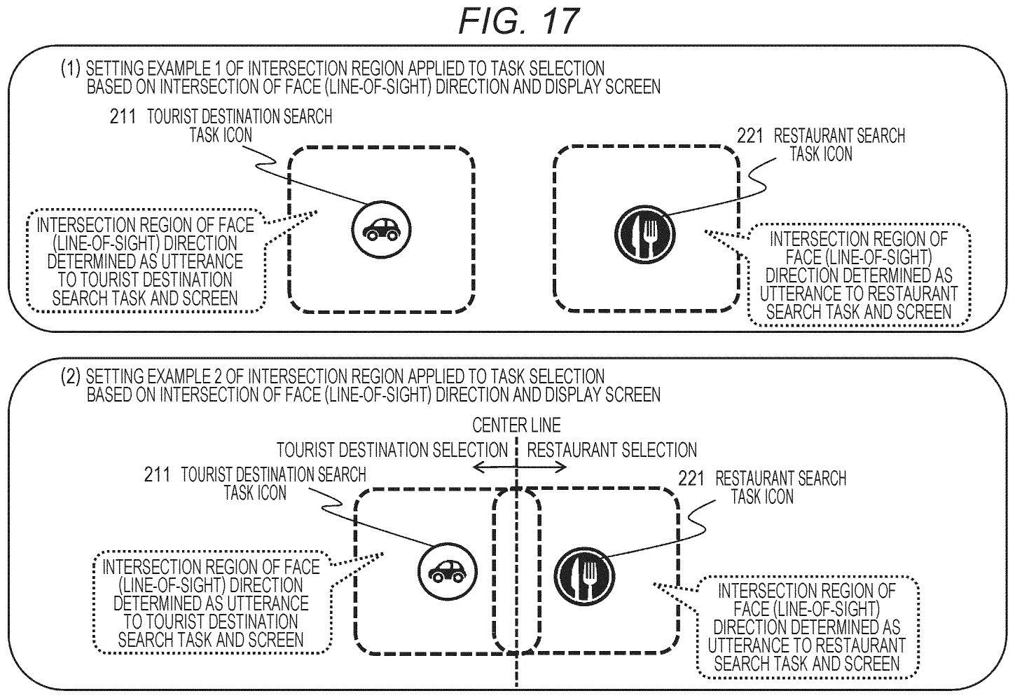

A specific example will be described with reference to FIG. 17.

The example illustrated in FIG. 17 is an example in which a rectangular region centered on the icon of each task is set as the line-of-sight determination region.

As illustrated in FIG. 17(1), in a case where the rectangular regions centered on two icons of each of the two tasks do not have overlapping regions, the user's line-of-sight vector falls within one of the line-of-sight determination regions, which enables determination of the required task without any problem.

However, for example, as illustrated in FIG. 17(2), in a case of having a region where rectangular regions centered on two icons of each of the two tasks overlap, there is a case where the user's line-of-sight vector falls within two line-of-sight determination regions, which makes determination of the required task difficult. In such a case, the task control and execution unit 140 uses the center lines of the two icons as determination dividing lines to perform the determination processing of the requested task. In the example illustrated in the drawing, if the intersection of the user's line-of-sight vector and the display surface is on the left of the center line, the processing of the tourist destination search task is performed, and if the intersection is on the right, the processing of the restaurant search task is performed.

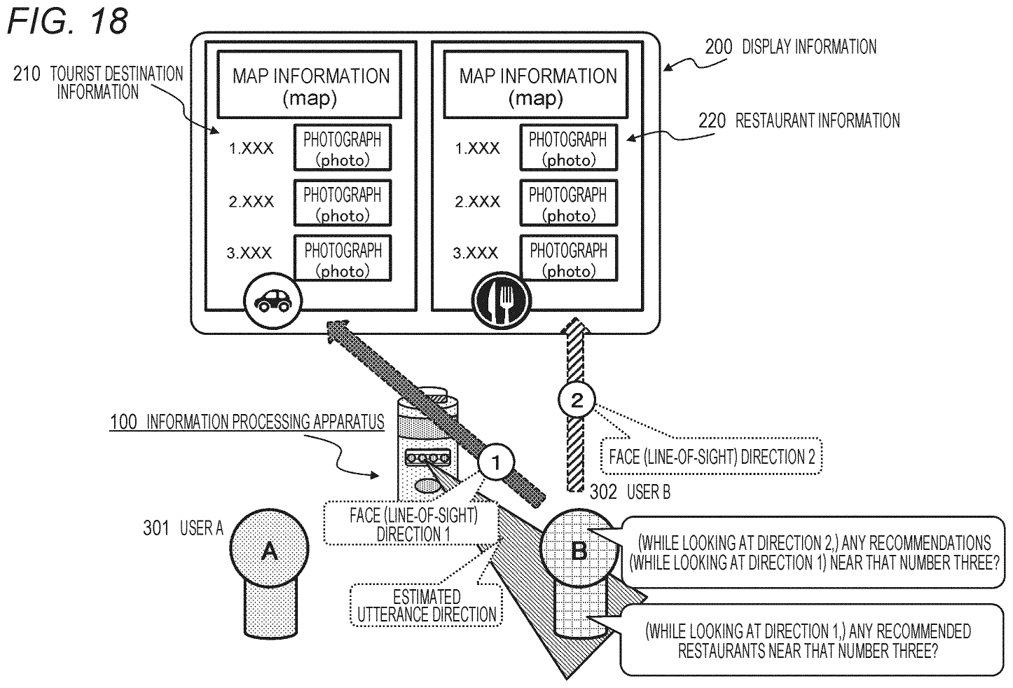

A specific example of task execution control by detecting an intersection between the user line-of-sight vector and the display surface of the display information will be described with reference to FIG. 18.

The example illustrated in FIG. 18 is a processing example in a case where the users B, 302 has made the following utterances while changing the line-of-sight direction as needed.

User utterance=(While looking at direction 2 (restaurant information)), any recommended one (while looking at direction 1 (tourist destination information)) near that number three?

In a case where there is such a user utterance, the task control and execution unit 140 first determines the user line-of-sight direction at the utterance timing of “number three”. In this case, the user line-of-sight direction at the utterance timing of “number three” is the direction 1 (tourist destination information). Therefore, it is determined that “number three” included in the user utterance is number three on the tourist destination information side.

Next, the user line-of-sight direction at the utterance timing of “Is there any recommended one?” is determined. In this case, the user line-of-sight direction at the utterance timing of “Any recommendations?” is direction 2 (restaurant information). Therefore, it is determined that “Any recommendations?” included in the user utterance is a request for the restaurant information.

As described above, the task control and execution unit 140 determines the task of interest of the user (viewed task) by detecting the user line-of-sight direction for each word included in the user utterance.

FIG. 18 also illustrates another utterance example of user B, 302. The utterance is as follows.

User utterance=(While looking at direction 1 (tourist destination information)), any recommended restaurant near that number three?

In this case, the task control and execution unit 140 first determines the user line-of-sight direction at the utterance timing of “number three”. In this case, the user line-of-sight direction at the utterance timing of “number three” is the direction 1 (tourist destination information). Therefore, it is determined that “number three” included in the user utterance is number three on the tourist destination information side.

Next, the user line-of-sight direction at the utterance timing of “Is there any recommended restaurant?” is determined. In this case, although the user line-of-sight direction at the utterance timing of “Is there any recommended restaurant?” is also the direction 1 (tourist information), it is determined that the request is for the restaurant information from the intention of “Is there any recommended restaurant?” included in the user utterance.

As described above, the task control and execution unit 140 performs task control based on the user's request in consideration of not only the line-of-sight direction but also the intention of the user utterance.

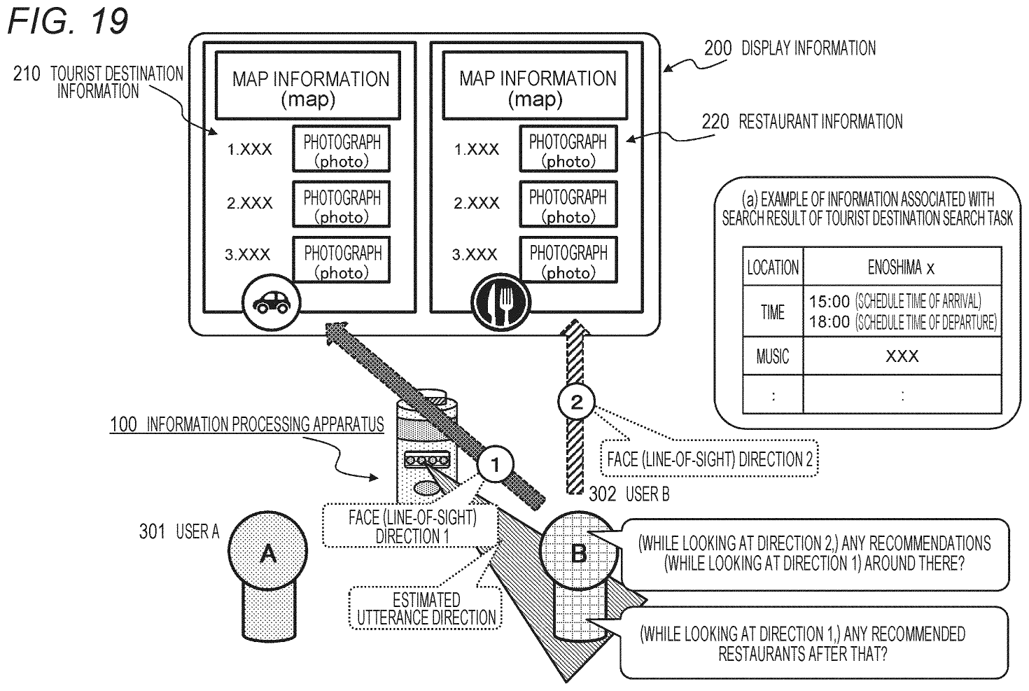

FIG. 19 is a diagram illustrating another processing example of task control by the task control and execution unit 140.

Also the example illustrated in FIG. 19 is a processing example in a case where the user B, 302 has made the following utterances while changing the line-of-sight direction as needed.

User utterance=(While looking at direction 2 (restaurant information)), any recommended one (while looking at direction 1 (tourist destination information)) around there?

Moreover, subsequently, User utterance=(While looking at direction 1 (tourist destination information)), any recommended restaurant after that?

In a case where there is such a user utterance, the task control and execution unit 140 first determines the user line-of-sight direction at the utterance timing of “around there”. In this case, the user line-of-sight direction at the utterance timing of “around there” is the direction 1 (tourist destination information). Therefore, it is determined that “around there” included in the user utterance is the area presented on the tourist destination information side.

Next, the user line-of-sight direction at the utterance timing of “Is there any recommended one?” is determined. In this case, the user line-of-sight direction at the utterance timing of “Any recommendations?” is direction 2 (restaurant information). Therefore, it is determined that “Any recommendations?” included in the user utterance is a request for the restaurant information.

Note that the information displayed as the execution result of each task is linked with various pieces of information other than the display information. Examples of various pieces of information include location address information, arrival time information when using transportation, recommended music information, and the like.

The task control and execution unit 140 can make a response to the user utterance by using these pieces of linked information.

For example,

User utterance=(While looking at direction 1 (tourist destination information)), any recommended restaurant after that?

In response to this user utterance, the task control and execution unit 140 can perform processing of executing the restaurant search task using the information linked with the tourist destination information being displayed to find the optimum restaurant according to the arrival time of the user, and presenting the search result.

### 5. Example of Execution Task Information Update Processing by Task Control and Execution Unit

Next, an example of execution task information update processing by the task control and execution unit 140 will be described.

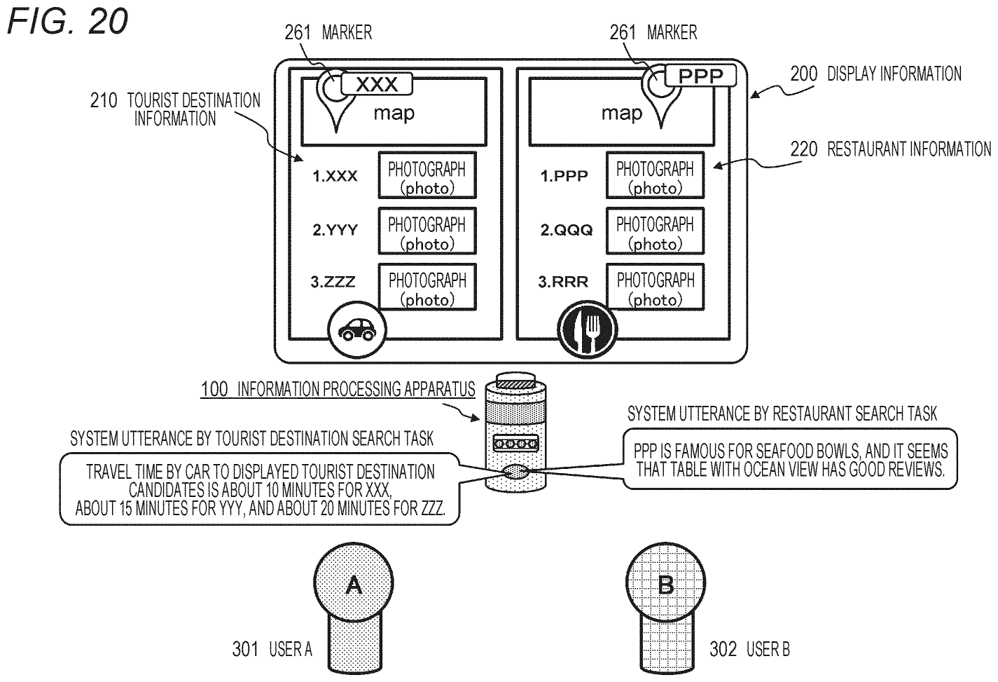

FIG. 20 is a diagram for explaining an example of information update processing of an execution task by the task control and execution unit 140.

This is a state where, as the display information 200, the tourist destination information 210 as the execution result of the tourist destination search task is displayed on the left side, and the restaurant information 220 as the execution result of the restaurant search task is displayed on the right side.

The task control and execution unit 140 not only displays the display information, but also performs various information providing processing for the user.

Specifically, the task control and execution unit 140 performs display content update processing and information providing processing by sound output. In the example illustrated in FIG. 20, the following system utterance is shown as the system utterance by the tourist destination search task.

System utterance=Travel time by car to displayed tourist destination candidates is about 10 minutes for XXX, about 15 minutes for YYY, and about 20 minutes for ZZZ.

Moreover, the following system utterance is shown as the system utterance by the restaurant search task.

System utterance=PPP, PPP is a restaurant famous for seafood bowls, and it seems that table with ocean view has good reviews.

Moreover, in each task, processing of such as displaying a marker 261 indicating a tourist destination or a restaurant location included in the system utterance on the displayed map is also performed.

Furthermore, additional information such as travel time to a restaurant or a tourist spot may be notified by image or sound. Furthermore, a configuration may be adopted where the display information related to the words included in the voice output may be highlighted or flashed.

These pieces of processing are all performed by the target task execution unit 143 of the task control and execution unit 140.

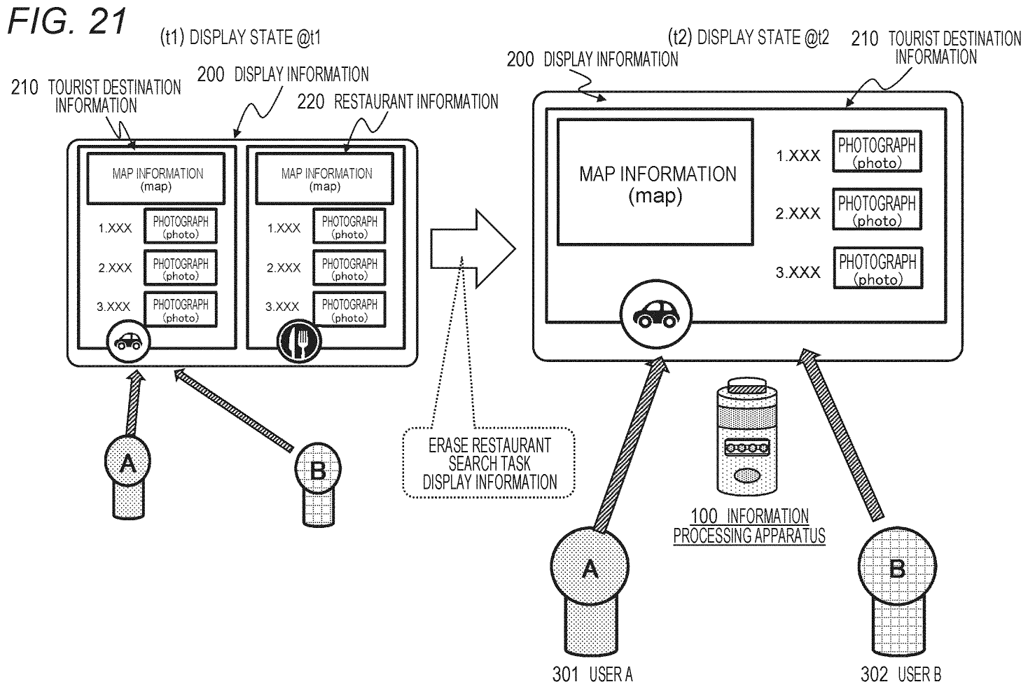

FIG. 21 is a diagram for explaining an example of task end processing performed by the target task execution unit 143 of the task control and execution unit 140.

For example, in a case where it is detected that the state in which nobody views the task being executed and the task is not processed by voice input has continued for a certain period of time, the target task execution unit 143 of the task control and execution unit 140 erases display related to the tasks being executed and performs optimal display with the remaining tasks.

The display information at time t1 is illustrated on the left side of FIG. 21. This is a state where, as the display information 200, the tourist destination information 210 as the execution result of the tourist destination search task is displayed on the left side, and the restaurant information 220 as the execution result of the restaurant search task is displayed on the right side.

The user A, 301 and user B, 302 are both looking at the tourist destination information 210.

In a case where it is detected that the state in which nobody views the restaurant information 220 and the information is not processed by voice input has continued for a certain period of time, the target task execution unit 143 of the task control and execution unit 140 erases display related to the restaurant information 220 and performs display in which the remaining tourist destination information 210 is enlarged in the entire display region. That is, the display mode is changed to the (t2) display state @t2 illustrated on the right side of FIG. 21.

Note that a setting may be adopted where, in erasing of the task display, the display data to be erased may be temporarily saved in the background and quickly restored if there is a call by a voice input within a fixed time. The task itself is stopped after a certain period of time.

### 6. Sequence of Processing Performed by Information Processing Apparatus

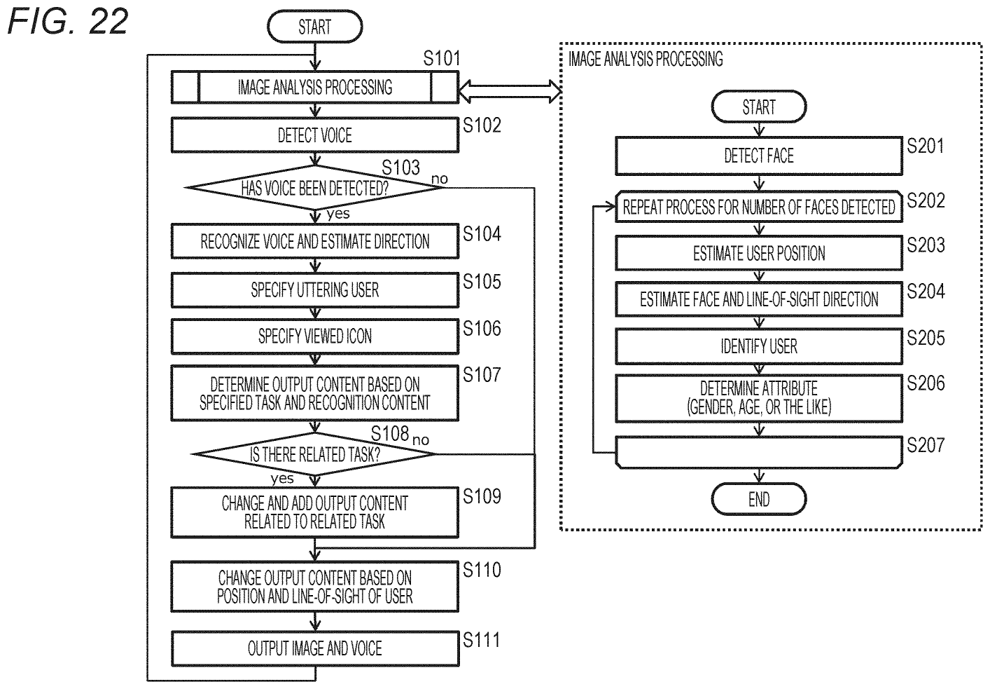

Next, a sequence of processing performed by the information processing apparatus 100 will be described with reference to a flowchart illustrated in FIG. 22.

Note that the processing shown in the flow of FIG. 22 can be performed according to a program stored in the storage unit of the information processing apparatus 100, and can be performed as a program execution processing, for example, by a processor such as a CPU having a program execution function.

The processing of each step of the flow illustrated in FIG. 22 will be described below.

(Step S101)

First, in step S101, image analysis processing is performed. This processing is processing performed by the image analysis unit 120 that has input the captured image of the imaging unit 102.

The detailed sequence of the image analysis processing of step S101 is processing of steps S201 to S207 on the right side of FIG. 22.

The processing of each step of steps S201 to S207 will be described.

(Step S201)

First, the image analysis unit 120 detects a face region from the captured image of the imaging unit 102. This processing is performed by the face detection unit 121 of the image analysis unit 120 described above with reference to FIG. 4. This processing is performed by applying an existing method such as collation processing with the facial feature information (pattern information) registered in advance in the storage unit.

The following processing of steps S202 to S207 is loop processing that is repeatedly performed for each detected face.

(Steps S202 to S207)

In steps S202 to S207, user position estimation processing, face (line-of-sight) direction estimation processing, user identification processing, and user attribute (gender, age, and the like) determination processing are performed for each face detected from the captured image of the imaging unit 102.

These pieces of processing are processing performed by the user position estimation unit 122, the face and line-of-sight direction estimation unit 123, the face identification unit 124, and the attribute determination processing unit 125 of the image analysis unit 120 described above with reference to FIG. 4. The user position estimation unit 122 estimates the position of the face detected by the face detection unit 121. The position, size, and the like of the face in the image are used to calculate the distance and direction from the information processing apparatus to determine the position of the user face. The position information is, for example, relative position information with respect to the information processing apparatus. Note that a configuration may be adopted where sensor information such as a distance sensor or a position sensor is used.

The face and line-of-sight direction estimation unit 123 estimates the face direction and line-of-sight direction detected by the face detection unit 121. The position of the eyes of the face, the position of the pupils of the eyes, and the like are detected to detect the face direction and the line-of-sight direction.

The face identification unit 124 sets an identifier (ID) for each of the faces detected by the face detection unit 121. In a case where a plurality of faces is detected in the image, a unique identifier capable of distinguishing each is set. Note that the user information DB 131 stores face information that has already been registered, and in a case where a matching face is identified by the comparison and collation processing with this registered face information, user name (registered name) thereof is also identified.

The attribute determination processing unit 125 acquires attribute information for each user identified by the face identification unit 124, for example, user attribute information such as age and gender. This attribute acquisition processing can be performed by estimating the attribute, for example, adult or child, male or female, on the basis of the captured image. Furthermore, in a case where the face identified by the face identification unit 124 is already registered in the user information DB 131 and the attribute information of the user is already recorded in the DB, this DB registration data may be acquired.

The acquisition and use methods of these components, that is, the face detection unit 121, the user position estimation unit 122, the face and line-of-sight direction estimation unit 123, the face identification unit 124, and the attribute determination processing unit 125 that are included the image analysis unit 120, are registered in the user information DB 131.

In step S101, the processing described above is performed for each face detected from the captured image of the imaging unit 102, and the information for each face is registered in the user information DB 131.

(Steps S102 and S103)

Next, in step S102, voice detection is performed. This processing is processing performed by the voice recognition unit 110 that inputs a voice signal via the voice input unit 101. This is performed by the voice detection unit 111 of the voice recognition unit 110 illustrated in FIG. 4.

In a case where it is determined in step S103 that voice has been detected, the process proceeds to step S104. In a case where it is determined that no voice has been detected, the process proceeds to step S110.

(Step S104)

Next, in step S104, voice recognition processing of the detected voice and voice direction (direction of utterance) estimation processing are performed.

This processing is performed by the voice direction estimation unit 112 and the utterance content recognition unit 113 of the voice recognition unit 110 illustrated in FIG. 4.

The voice direction estimation unit 112 estimates the direction of the user who made the utterance, that is, the voice direction. As described above, the voice input unit (microphone) 101 is configured as a microphone array including a plurality of microphones capable of specifying a sound source direction, and estimates the voice direction on the basis of the phase difference of the acquired voice of each microphone.

The utterance content recognition unit 113 uses, for example, an automatic speech recognition (ASR) function to convert voice data into text data including a plurality of words. Moreover, the utterance content recognition unit 113 performs utterance semantic analysis processing for the text data.

(Step S105)

Next, in step S105, the uttering user is specified. This processing is processing performed by the task and control execution unit 140. This processing is performed by the uttering user specifying unit 141 of the task and control execution unit 140 illustrated in FIG. 6. This processing is performed using the user position information associated with the utterance content stored in the user information DB 131. This processing may be performed as processing of using the estimation information of the utterance direction to specify the user of the face in that direction.

(Step S106)

Next, in step S106, the viewed icon of each user is specified. This processing is performed by the viewed task specifying unit 142 of the task and control execution unit 140 illustrated in FIG. 6. The viewed task specifying unit 142 performs processing for specifying the display task included in the captured image of the imaging unit 102 and viewed by the user. This processing is performed using the user position information stored in the user information DB 131 and the face (line-of-sight) direction information.

(Step S107)

Next, in step S107, a processing task is determined on the basis of the viewed task specified in step S106 and the voice recognition result acquired in step S104, and processing by the task is performed. This processing is performed by the target task execution unit 143 of the task and control execution unit 140 illustrated in FIG. 6. The target task execution unit 143, for example, specifies a task that the user is viewing or a task whose display is to be changed on the basis of the user utterance, and performs processing related to the task.

(Steps S108 and S109)

Next, in steps S108 and S109, it is determined whether or not there is a related task related to the task currently executing the processing, and in a case where there is, change processing or addition processing of the output content related to the related task is performed. This processing is performed by the related task update unit 144 of the task and control execution unit 140 illustrated in FIG. 6.

(Step S110)

Next, in step S110, processing of changing output information such as display information by the task currently being executed according to the latest position of the user, line-of-sight direction, and others are performed. This processing is performed by the display position and shape determination unit 145 of the task and control execution unit 140 illustrated in FIG. 6.

The display position and shape determination unit 145 determines the display position and shape of the task being displayed on the display unit 163, and updates the display information to the determined position and shape.

Note that the processing of steps S105 to S110 is processing performed by the task and control execution unit 140, and specifically, various pieces of processing described with reference to FIGS. 8 to 21 are performed.

(Step S111)

Finally, in step S111, the image. Voice output processing is performed. The output contents of the image and voice are determined by the task being executed in the task and control execution unit 140. The display information and video information determined by this task are output via the voice output unit 162 and the image output unit 163 under the control of the output control unit 161.

### 7. Configuration Example of Information Processing Apparatus and Information Processing System

Although the processing functions of each component of the information processing apparatus 100 illustrated in FIG. 3 can be configured in one apparatus, for example, in an apparatus such as an agent device, a smartphone or a PC owned by the user, and the functions can be configured such that a part of the functions is performed in a server or the like.

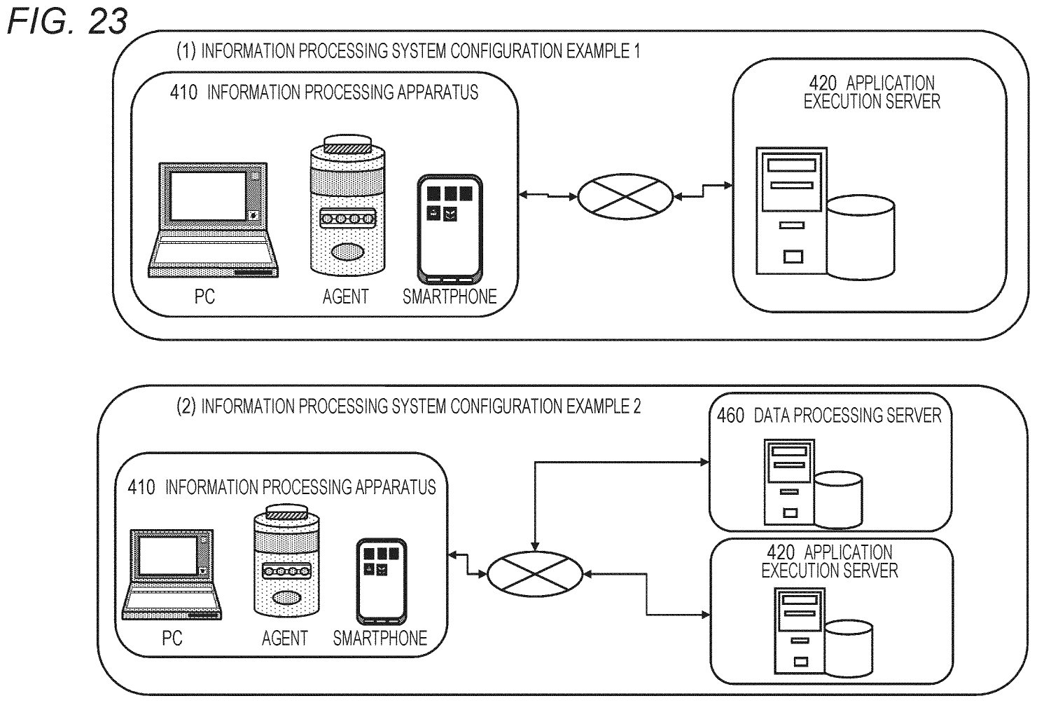

FIG. 23 illustrates an example of a system configuration for performing the processing of the present disclosure.

(1) Information processing system configuration example 1 in FIG. 23 is an example where almost all the functions of the information processing apparatus illustrated in FIG. 3 are included in one device, for example, in an information processing apparatus 410 that is a smartphone or PC owned by the user, or a user terminal such as an agent device having a voice input and output function and an image input and output function.

The information processing apparatus 410 corresponding to the user terminal performs communication with an application execution server 420 only a case of using an external application when generating a response sentence, for example.

The application execution server 420 is, for example, a weather information providing server, a traffic information providing server, a medical information providing server, a tourist information providing server, and the like, and is configured by a server group capable of providing information for generating a response to a user utterance.

On the other hand, (2) information processing system configuration example 2 in FIG. 23 is an example of a system where a part of the functions of the information processing apparatus illustrated in FIG. 3 is included in the information processing apparatus 410 that is an information processing terminal such as a smartphone, a PC, or an agent device owned by the user, and a part is performed in a data processing server 460 capable of communicating with the information processing apparatus.

For example, a configuration is possible in which the processing performed by the voice recognition unit 110 or the image analysis unit 120 in the apparatus illustrated in FIG. 3 is performed on the server side. The acquired data of the voice input unit 101 and the imaging unit 102 on the information processing apparatus 410 side on the information processing terminal side is transmitted to the server, and analysis data is generated on the server side. The information processing terminal is configured to perform control and execution of a task using server analysis data.

The task control and execution unit on the information processing terminal side performs processing of changing the display position and shape of the task correspondence information according to the user position included in the analysis data generated by the server. Note that various different settings are possible for the function division mode of the function on the side of the information processing terminal such as the user terminal and the function on the side of the server, and a configuration in which one function is performed on both sides is also possible.

### 8. Hardware Configuration Example of Information Processing Apparatus

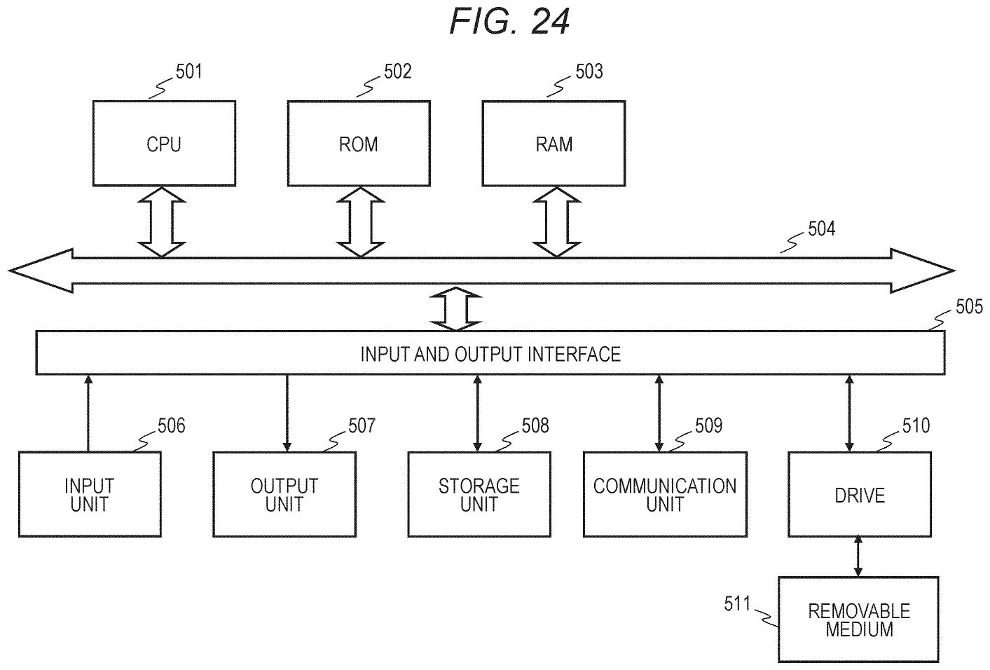

Next, a hardware configuration example of the information processing apparatus will be described with reference to FIG. 24.

The hardware described with reference to FIG. 24 has the hardware configuration example of the information processing apparatus described above with reference to FIG. 3, and is an example of the hardware configuration of the information processing apparatus composing the data processing server 460 described with reference to FIG. 23.

A central processing unit (CPU) 501 functions as a control unit or a data processing unit that performs various types of processing according to a program stored in a read only memory (ROM) 502 or a storage unit 508. For example, processing according to the sequence described in the above-described embodiment is performed. A random access memory (RAM) 503 stores programs executed by the CPU 501, data, and the like. The CPU 501, the ROM 502, and the RAM 503 are mutually connected via a bus 504.

The CPU 501 is connected to an input and output interface 505 via the bus 504, the input and output interface 505 is connected to an input unit 506 including various types switches, a keyboard, a mouse, a microphone, a sensor, and the like, and an output unit 507 including a display, a speaker, and the like. The CPU 501 performs various types of processing correspondingly to a command input from the input unit 506, and outputs a processing result to, for example, the output unit 507.

The storage unit 508 connected to the input and output interface 505 includes, for example, a hard disk or the like, and stores a program executed by the CPU 501 and various types of data. The communication unit 509 functions as a transmission and reception unit for Wi-Fi communication, Bluetooth (registered trademark) (BT) communication, and other data communication via a network such as the Internet or a local area network, and communicates with an external device.

A drive 510 connected to the input and output interface 505 drives a removable medium 511 such as a magnetic disk, an optical disk, a magneto-optical disk, or a semiconductor memory such as a memory card to record or read data.

### 9. Summary of Configuration of Present Disclosure

As described above, the embodiments of the present disclosure have been described in detail with reference to specific embodiments. However, it is obvious that those skilled in the art can make modifications and substitutions of the embodiments without departing from the gist of the present disclosure. That is, the present invention has been disclosed in the form of exemplification, and should not be interpreted in a limited manner. In order to determine the gist of the present disclosure, the column of the scope of claims should be taken into consideration.

Note that the technology disclosed in this specification can take the following configurations.

(1) An information processing apparatus including:

a voice recognition unit that performs analysis processing of voice input via a voice input unit;

an image analysis unit that performs analysis processing of a captured image input via an imaging unit;

a task control and execution unit that performs processing according to a user utterance; and

a display unit that outputs task correspondence information that is display information based on execution of a task by the task control and execution unit,

in which the task control and execution unit

changes a display position of the task correspondence information according to a user position.

(2) The information processing apparatus according to (1), in which the task control and execution unit

performs control of changing at least one of a display position or a display shape of the task correspondence information according to the user position.

(3) The information processing apparatus according to (1) or (2), in which the task control and execution unit

performs control of changing at least one of a display position or a display shape of the task correspondence information according to a face or a line-of-sight direction of a user.

(4) The information processing apparatus according to any one of (1) to (3), in which, in a case where a plurality of pieces of the task correspondence information is displayed on the display unit,

the task control and execution unit

performs task-based display position control such that the display position of each piece of the task correspondence information is close to the user position of a user who has requested execution of each task.

(5) The information processing apparatus according to any one of (1) to (4),

in which the image analysis unit analyzes the user position, and

the task control and execution unit

changes at least one of a display position or a display shape of the task correspondence information in the display unit on the basis of user position information analyzed by the image analysis unit.

(6) The information processing apparatus according to any one of (1) to (5), in which the image analysis unit

stores user information including user position information acquired by analysis processing of the captured image in a user information database.

(7) The information processing apparatus according to (6), in which the task control and execution unit

uses stored information of the user information database to determine a change mode of at least one of a display position or a display shape of the task correspondence information.

(8) The information processing apparatus according to any one of (1) to (7), in which the task control and execution unit

calculates an intersection between a user line-of-sight vector and the display information to specify the task correspondence information displayed at a calculated intersection position as a user viewed task, and

performs processing of the viewed task in response to the user utterance.

(9) The information processing apparatus according to any one of (1) to (8), in which the task control and execution unit

performs processing of calculating an intersection between a user line-of-sight vector and the display information in units of words included in the user utterance to specify the task correspondence information displayed at a calculated intersection position as a user viewed task.

(10) The information processing apparatus according to any one of (1) to (9), in which the task control and execution unit

stores task information including display region information of the task correspondence information in a task information database.

(11) The information processing apparatus according to (10), in which the task control and execution unit

stores an identifier of a related task related to a task being executed in the task information database.

(12) The information processing apparatus according to any one of (1) to (11),

in which the voice recognition unit

performs utterance direction estimation processing of the user utterance, and

the task control and execution unit

changes at least one of a display position or a display shape of the task correspondence information in the display unit according to an utterance direction estimated by the voice recognition unit.

(13) An information processing system including: an information processing terminal; and a server,

the information processing terminal including:

a voice input unit; an imaging unit;

a task control and execution unit that performs processing according to a user utterance; and

a communication unit that transmits voice acquired via the voice input unit and a captured image acquired via the imaging unit to the server,

in which the server

generates utterance contents of the speaker, an utterance direction, and a user position indicating a position of a user included in the captured image by a camera on the basis of received data from the information processing terminal as analysis information, and

the task control and execution unit of the information processing terminal

uses the analysis information generated by the server to perform execution and control of a task.

(14) The information processing system according to (13), in which the task control and execution unit of the information processing terminal

changes a display position of the task correspondence information according to the user position generated by the server.

(15) An information processing method performed in an information processing apparatus, the method including:

performing analysis processing of voice input via a voice input unit by a voice recognition unit;

performing analysis processing of a captured image input via an imaging unit by an image analysis unit; and

outputting task correspondence information that is display information based on execution of a task for performing processing according to a user utterance, to a display unit, and changing a display position of the task correspondence information according to a user position by a task control and execution unit.

(16) An information processing method performed in an information processing system including an information processing terminal and a server, the method including:

by the information processing terminal,

transmitting voice acquired via a voice input unit and a captured image acquired via an imaging unit to the server;

by the server,

generating utterance contents of the speaker, an utterance direction, and a user position indicating a position of a user included in the captured image by a camera on the basis of received data from the information processing terminal as analysis information; and

by the information processing terminal,

using the analysis information generated by the server to perform execution and control of a task, and changing a display position of task correspondence information according to the user position generated by the server.

(17) A program that causes information processing to be performed in an information processing apparatus, the program causing:

a voice recognition unit to perform analysis processing of voice input via a voice input unit;

an image analysis unit to perform analysis processing of a captured image input via an imaging unit; and

a task control and execution unit to output task correspondence information that is display information based on execution of a task according to a user utterance to a display unit, and change a display position of the task correspondence information according to a user position.

Furthermore, the series of pieces of processing described in the specification can be performed by hardware, software, or a combined configuration of both. In a case of performing processing by software, the program in which the processing sequence is recorded can be installed in a memory in a computer incorporated in dedicated hardware and executed, or the program can be installed on a general-purpose computer capable of performing various processing and executed. For example, the program can be recorded in advance on a recording medium. In addition to being installed on a computer from a recording medium, the program can be received via a network such as a local area network (LAN) or the Internet and installed on a recording medium such as a built-in hard disk.

Note that the various types of processing described in the specification are not only performed in time series according to the description, but may be performed in parallel or individually according to the processing capability of the apparatus that performs the processing or as necessary. Furthermore, in this specification, a system is a logical set configuration of a plurality of devices, and is not limited to one in which the devices of each configuration are in the same housing.

### INDUSTRIAL APPLICABILITY

As described above, according to the configuration of an embodiment of the present disclosure, an apparatus and a method that identify a task of interest of a user and control display of task correspondence information are achieved.

Specifically, for example, an image analysis unit that performs analysis processing of a captured image, a task control and execution unit that performs processing according to a user utterance, and a display unit that outputs task correspondence information that is display information based on execution of a task in the task control and execution unit. The task control and execution unit performs control of changing the display position and the display shape of the task correspondence information according to a user position and a face or a line-of-sight direction of a user. In a case where a plurality of pieces of task correspondence information is displayed on the display unit, task-based display control is performed such that the display position of each piece of task correspondence information is close to a user position of the user who has requested execution of each task.

With this configuration, an apparatus and a method that identify a task of interest of a user and control display of task correspondence information are achieved.

### REFERENCE SIGNS LIST

10 Information processing apparatus
11 Imaging unit
12 Microphone
13 Display unit
14 Speaker
20 Server
30 External device
101 Voice input unit
102 Imaging unit
110 Sound recognition unit
111 Voice detection unit
112 Voice direction estimation unit
113 Utterance content recognition unit
120 Image analysis unit
121 Face detection unit
122 User position estimation unit
123 Face and line-of-sight direction estimation unit
124 Face identification unit
125 Attribute determination processing unit
131 User information DB
140 Task control and execution unit
141 Utterance user specifying unit
142 Viewed task specifying unit
143 Target task execution unit
144 Related task update unit
145 Display position and shape determination unit
151 Task information DB
161 Output control unit
162 Voice output unit
163 Display unit
171 Communication unit
410 Information processing apparatus
420 Application execution server
460 Data processing server
501 CPU
502 ROM
503 RAM
504 Bus
505 Input and output interface
506 Input unit
507 Output unit
508 Storage unit
509 Communication unit
510 Drive
511 Removable medium

1. An information processing apparatus comprising:
a voice recognition unit that performs analysis processing of voice input via a voice input unit;
an image analysis unit that performs analysis processing of a captured image input via an imaging unit;
a task control and execution unit that performs processing according to a user utterance; and
a display unit that outputs task correspondence information that is display information based on execution of a task by the task control and execution unit,
wherein the task control and execution unit
changes a display position of the task correspondence information according to a user position.

2. The information processing apparatus according to claim 1, wherein the task control and execution unit
performs control of changing at least one of a display position or a display shape of the task correspondence information according to the user position.

3. The information processing apparatus according to claim 1, wherein the task control and execution unit
performs control of changing at least one of a display position or a display shape of the task correspondence information according to a face or a line-of-sight direction of a user.

4. The information processing apparatus according to claim 1, wherein, in a case where a plurality of pieces of the task correspondence information is displayed on the display unit,
the task control and execution unit
performs task-based display position control such that the display position of each piece of the task correspondence information is close to the user position of a user who has requested execution of each task.

5. The information processing apparatus according to claim 1,
wherein the image analysis unit analyzes the user position, and
the task control and execution unit
changes at least one of a display position or a display shape of the task correspondence information in the display unit on a basis of user position information analyzed by the image analysis unit.

6. The information processing apparatus according to claim 1, wherein the image analysis unit
stores user information including user position information acquired by analysis processing of the captured image in a user information database.

7. The information processing apparatus according to claim 6, wherein the task control and execution unit
uses stored information of the user information database to determine a change mode of at least one of a display position or a display shape of the task correspondence information.

8. The information processing apparatus according to claim 1, wherein the task control and execution unit
calculates an intersection between a user line-of-sight vector and the display information to specify the task correspondence information displayed at a calculated intersection position as a user viewed task, and
performs processing of the viewed task in response to the user utterance.

9. The information processing apparatus according to claim 1, wherein the task control and execution unit
performs processing of calculating an intersection between a user line-of-sight vector and the display information in units of words included in the user utterance to specify the task correspondence information displayed at a calculated intersection position as a user viewed task.

10. The information processing apparatus according to claim 1, wherein the task control and execution unit
stores task information including display region information of the task correspondence information in a task information database.

11. The information processing apparatus according to claim 10, wherein the task control and execution unit
stores an identifier of a related task related to a task being executed in the task information database.

12. The information processing apparatus according to claim 1,
wherein the voice recognition unit
performs utterance direction estimation processing of the user utterance, and
the task control and execution unit
changes at least one of a display position or a display shape of the task correspondence information in the display unit according to an utterance direction estimated by the voice recognition unit.

13. An information processing system comprising: an information processing terminal; and a server,
the information processing terminal comprising:
a voice input unit; an imaging unit;
a task control and execution unit that performs processing according to a user utterance; and
a communication unit that transmits voice acquired via the voice input unit and a captured image acquired via the imaging unit to the server,
wherein the server
generates utterance contents of the speaker, an utterance direction, and a user position indicating a position of a user included in the captured image by a camera on a basis of received data from the information processing terminal as analysis information, and
the task control and execution unit of the information processing terminal
uses the analysis information generated by the server to perform execution and control of a task.

14. The information processing system according to claim 13, wherein the task control and execution unit of the information processing terminal
changes a display position of the task correspondence information according to the user position generated by the server.

15. An information processing method performed in an information processing apparatus, the method comprising:
performing analysis processing of voice input via a voice input unit by a voice recognition unit;
performing analysis processing of a captured image input via an imaging unit by an image analysis unit; and
outputting task correspondence information that is display information based on execution of a task for performing processing according to a user utterance, to a display unit, and changing a display position of the task correspondence information according to a user position by a task control and execution unit.

16. An information processing method performed in an information processing system including an information processing terminal and a server, the method comprising:
by the information processing terminal,
transmitting voice acquired via a voice input unit and a captured image acquired via an imaging unit to the server;
by the server,
generating utterance contents of the speaker, an utterance direction, and a user position indicating a position of a user included in the captured image by a camera on a basis of received data from the information processing terminal as analysis information; and
by the information processing terminal,
using the analysis information generated by the server to perform execution and control of a task, and changing a display position of task correspondence information according to the user position generated by the server.

17. A program that causes information processing to be performed in an information processing apparatus, the program causing:
a voice recognition unit to perform analysis processing of voice input via a voice input unit;
an image analysis unit to perform analysis processing of a captured image input via an imaging unit; and
a task control and execution unit to output task correspondence information that is display information based on execution of a task according to a user utterance to a display unit, and change a display position of the task correspondence information according to a user position.
